(19) United States
(12) Patent Application Publication
(10) Pub. No.: US 2026/0254638 A1
(43) Pub. Date: Aug. 27, 2026

(54) Zero-Knowledge Secure and Private Monitoring Channel

(71) Applicant: Dashlane SAS, Paris (FR)

(72) Inventors: Guillaume MARON, Paris (FR); Ludovic WIDMER, Clichy (FR); Emmanuelle FRANQUELIN, Salles-la-Source (FR); Frederic RIVAIN, Brooklyn, NY (US)

(73) Assignee: Dashlane SAS, Paris (FR)

(21) Appl. No.: 19/267,168

(22) Filed: Jul. 11, 2025

Related U.S. Application Data
(60) Provisional application No. 63/693,350, filed on Sep. 11, 2024.

(51) Int. Cl. H04L 9/30; H04L 9/32

(52) U.S. Cl. CPC H04L 9/3073; H04L 9/3271

(57) ABSTRACT

Systems and methods for securely and privately monitoring risky web activities in an enterprise computing system. A service is provided that communicates with a first client-application deployed on a user device and a second client-application deployed on an administrator device. A secure enclave is deployed by the service that ensures zero-knowledge to store sensitive user data (e.g., activity logs of risky web activity logged by the first client-application). Team-Service Logged-Out keys and Team-Enclave Logged-Out keys are deployed to the user device. When an end user associated with the user device is not logged into the service, the Team-Service Logged-Out keys and Team-Enclave Logged-Out keys are used to authenticate the logged-out end user so that an activity log can be sent to the secure enclave and stored. The activity log can be accessed by the second client-application upon authentication of the administrator using a Device-Enclave key pair associated with the administrator.

### CROSS-REFERENCE TO RELATED APPLICATIONS

This application claims the benefit of U.S. Provisional Patent Application No. 63/693,350, titled “ZERO-KNOWLEDGE, SECURE AND PRIVATE MONITORING CHANNEL OF RISKY WEB ACTIVITIES FOR UNAUTHENTICATED USERS,” filed Sep. 11, 2024, which is incorporated by reference herein in its entirety.

### BACKGROUND

Stolen user credentials are oftentimes a result of risky user behaviors that expose the user credentials to potential attackers. Using stolen user credentials is a primary method attackers use to gain access to computing systems and associated data. Thus, an enterprise may seek to protect users that interact with the enterprise's computing system and the users'credentials to reduce the risk of security breaches. Thus, an enterprise may monitor user activity for risky user behaviors (e.g., to help identify and mitigate security risks before they lead to breaches).

Typically, monitoring methods are either noncomprehensive and/or introduce potential risks. For instance, single sign-on (SSO) and/or endpoint protection are used for providing enterprise security; however, such tools are limited to monitoring risky user behavior within a controlled environment. As an example, such tools may be limited to monitoring device level activity or activity within enterprise applications integrated with the SSO system. In some cases, a security tool, such as a password manager, is used to protect user credentials. However, in an enterprise setting, users may choose not to use the password manager and perform risky user behaviors (e.g., manually typing weak passwords or reusing compromised credentials) that can be exploited by attackers. In other cases, a security tool may be used to monitor risky user behaviors (e.g., performed in a web browser). For instance, a web behavior monitoring tool may be used to prevent users from visiting malicious websites or from downloading harmful files. However, use of such a tool may introduce additional security risks to the enterprise computing system due to a lack of a “zero-knowledge” architecture (e.g., a privacy-focused design where the service provider cannot access the data it processes or stores). For instance, a web behavior monitoring tool may generate logs of risky user behavior (e.g., web activities), which are monitored by a service provider of the monitoring tool. If the service provider is compromised, the logs may be exposed, where sensitive information about risky user behavior may be misused by an attacker. Thus, monitoring of risky web activity is often incomplete or performed in a way that exposes the enterprise to additional vulnerabilities.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure describe systems and methods for providing secure and private monitoring of sensitive data in an enterprise computing system. According to examples, the system includes a service, a first client-application associated with the service deployed on a user device associated with an end user, and a second client-application associated with the service deployed on an administrator device associated with an administrator. A secure enclave is deployed by the service that ensures zero-knowledge to store sensitive user data. For instance, the first client-application may be configured to monitor user interactions in a target application on the user device, such as web activities performed in a web browser.

Device-Enclave keys are created and are attributed to an end user and a user device. The Device-Enclave keys may be used to authenticate the end user to the secure enclave so that an activity log generated by the first client-application can be sent to the secure enclave and stored when the end user is logged into the service. Additionally, Team-Service Logged-Out keys and Team-Enclave Logged-Out keys are deployed to the user device and are used to sign challenges when the end user is not logged into the service and/or when the end user does not have an account with the service. For instance, the Team-Service Logged-Out keys and Team-Enclave Logged-Out keys are used to authenticate the logged-out or account-less end user so that an activity log can be sent to the secure enclave and stored when the end user is not logged into the service. In examples, the activity log can be accessed by the second client-application upon authentication of the administrator using a Device-Enclave key pair associated with the administrator.

According to an aspect, a method is provided, comprising: generating, by a service, a team-service logged-out key pair, including a team-service logged-out public key and a team-service logged-out secret key; generating, by a secure enclave associated with the service, a team-enclave logged-out key pair, including a team-enclave logged-out public key and a team-enclave logged-out secret key; deploying the team-service logged-out secret key and the team-enclave logged-out secret key to a first computing device associated with a first user; and while the first user is logged out from the service: sending, by the service, a first challenge to the first computing device; receiving, by the service, a first response to the first challenge; authenticating, by the service and using the team-service logged-out public key, the first response is signed by the team-service logged-out secret key; sending, by the secure enclave, a second challenge to the first computing device; receiving, by the secure enclave, a second response to the second challenge; authenticating, by the secure enclave and using the team-enclave logged-out public key, the second response is signed by the team-enclave logged-out secret key; and receiving, from a first client application associated with the service and deployed on the first computing device, a first activity log of risky web activity detected in a target application.

According to another aspect, a system is provided comprising: one or more processors; and memory including instructions, which when executed by the one or more processors, cause the system to perform operations comprising: generating, by a service, a team-service logged-out key pair, including a team-service logged-out public key and a team-service logged-out secret key; generating, by a secure enclave associated with the service, a team-enclave logged-out key pair, including a team-enclave logged-out public key and a team-enclave logged-out secret key; deploying the team-service logged-out secret key and the team-enclave logged-out secret key to a first computing device associated with a first user; and while the first user is logged out from the service: sending, by the service, a first challenge to the first computing device; receiving, by the service, a first response to the first challenge; authenticating, by the service and using the team-service logged-out public key, the first response is signed by the team-service logged-out secret key; sending, by the secure enclave, a second challenge to the first computing device; receiving, by the secure enclave, a second response to the second challenge; authenticating, by the secure enclave and using the team-enclave logged-out public key, the second response is signed by the team-enclave logged-out secret key; and receiving, from a first client application associated with the service and deployed on the first computing device, a first activity log of risky web activity detected in a target application.

According to another aspect, a method is provided, comprising: method, comprising: receiving a first challenge from a service; authenticating with the service by signing the first challenge with a device-service secret key of a device-service key pair associated with an administrator computing device and an administrator user; providing a first request to the service for creation of a team-service logged-out key pair, including a team-service logged-out public key and a team-service logged-out secret key; receiving a first response to the first request from the service including the team-service logged-out key pair; receiving a second challenge from a secure enclave associated with the service; authenticating with the secure enclave by signing the second challenge with a device-enclave secret key of a device-enclave key pair associated with the administrator computing device and the administrator user; providing a second request to the secure enclave for creation of a team-enclave logged-out key pair, including a team-enclave logged-out public key and a team-enclave logged-out secret key; receiving a second response to the second request from the secure enclave including the team-enclave logged-out key pair; deploying a risky activity monitor associated with the service on a user computing device associated with an end user; deploying the team-service logged-out secret key and the team-enclave logged-out secret key to the user computing device; and configuring the risky activity monitor to: monitor a target application; detect a risky event; log the risky event in an activity log; receive an indication the end user is logged out from the service; authenticate with the service using the team-service logged-out key pair; authenticate with the secure enclave using the team-enclave logged-out key pair; and send the activity log to the secure enclave.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF DRAWINGS

Non-limiting and non-exhaustive examples are described with reference to the following figures.

FIG. 1 depicts an example system in which a service and client applications may be implemented for providing secure and private monitoring of sensitive data in an enterprise computing system;

FIG. 2 depicts an example method for initializing a secure enclave for the service;

FIG. 3 depicts a method of enrolling a first device for a user of the service;

FIG. 4 depicts an example method of enrolling a second device for the user;

FIG. 5 depicts an example method of creating team logged-out keys;

FIG. 6 depicts a first example method of deploying the team logged-out keys to one or more user computing devices in the enterprise computing system;

FIG. 7 depicts a second example method of deploying the team logged-out keys to user computing devices;

FIG. 8A depicts an example method of securely and privately logging and storing risky web activity in the enterprise computing system of a logged-out user;

FIG. 8B depicts an example method of securely and privately logging and storing risky web activity in the enterprise computing system of a logged-in user;

FIG. 9 depicts an example method of securely and privately reading risky web activity logs;

FIG. 10 depicts a first example method including operations that may be performed by the client application operating on an administrator computing device to provide secure and private monitoring of risky web activity in the enterprise computing system;

FIG. 11 depicts an example method including operations that may be performed by the client application operating on a user computing device to provide secure and private monitoring of risky web activity in the enterprise computing system;

FIG. 12 depicts a second example method including operations that may be performed by the client application operating on the administrator computing device to provide secure and private monitoring of risky web activity in the enterprise computing system;

FIG. 13 depicts a first example method including operations that may be performed by the service to provide secure and private monitoring of risky web activity in the enterprise computing system;

FIG. 14 depicts a second example method including operations that may be performed by the service to provide secure and private monitoring of risky web activity in the enterprise computing system; and

FIG. 15 is a block diagram of a computing device with which examples of the present disclosure may be practiced according to an example.

### DETAILED DESCRIPTION

In the following detailed description, references are made to the accompanying drawings that form a part hereof, and in which are shown by way of illustrations specific embodiments or examples. However, examples may be implemented in many different forms and should not be construed as limited to the embodiments set forth herein; rather, these examples are provided so that this disclosure will be thorough and complete and will fully convey the scope of the examples to those skilled in the art. Examples may be practiced as methods, systems, or devices. Accordingly, examples may take the form of a hardware implementation, an entirely software implementation or an implementation combining software and hardware aspects. The following detailed description is, therefore, not to be taken in a limiting sense.

Aspects of the present disclosure include a system and method that provide secure and private monitoring of sensitive data in a computing system. The system and method are used to establish a secure operating environment in which sensitive data relating to risky activities performed in a target application (e.g., a web browser) is logged and managed in accordance with zero-knowledge principles. As used herein, risky user behavior (also referred to as “risky activity” or “risky activities”) may comprise user-initiated activity within a target application that violates a defined security rule or preference for the application. In examples, risky user behavior may comprise risky web activity detected in a web browser application. In examples, security rules and preferences for determining risky user behavior may be specifically defined (and/or editable) on a per-application basis. In addition, risky user behavior may, in examples, include interactions detected within a target application that the application would treat as a user interaction even if the inputs are provided to the application by another computing system. Some examples of risky activities include using weak or compromised passwords, visiting malware-infected or phishing websites, and/or other activities that may introduce or otherwise facilitate unauthorized access, data breaches, malware infections, or other security vulnerabilities within the enterprise computing system. According to examples, a risky activity monitor is installed on a first computing device of an enterprise computing system that interfaces the target application and logs risky activities performed in the target application. For instance, details of risky activities (e.g., of a particular user using a weak or compromised password on a particular website) are logged and transmitted, via a secure communication channel, to a secure enclave server (e.g., owned and operated by a secure enclave provider and controlled and used by a service provider) leveraging a cloud-based secure enclave. The secure enclave allows for the logged risky activity data to be stored by the service provider while ensuring zero-knowledge by the service provider. In examples, the risky activity monitor logs risky activities performed in the target application regardless of whether the user of the first computing device is authenticated or actively using a security tool (e.g., a password manager) provided by the service provider.

In some examples, a risky activity manager is installed on a second computing device of the enterprise computing system that allows an administrative user to read logged risky activity data from the secure enclave. In examples, security rules and preferences for determining risky user behavior may be defined (and/or editable) within the risky activity manager for a particular application. For instance, the administrative user may have visibility into security risks to the enterprise computing system, without exposing the security risks to malicious users who could use such information to target an attack. Risky activity logs may allow administrative users of the enterprise to take proactive measures to address security vulnerabilities, enforce security policies, and/or perform other actions to mitigate security risks. In further examples, the risky activity manager provides automatic feedback to the computing device user when a particular security vulnerability is detected. For instance, the risky activity manager may be configured to analyze risky activity log data and programmatically provide contextual guidance, alerts, recommendations, coaching, and/or training to increase online security.

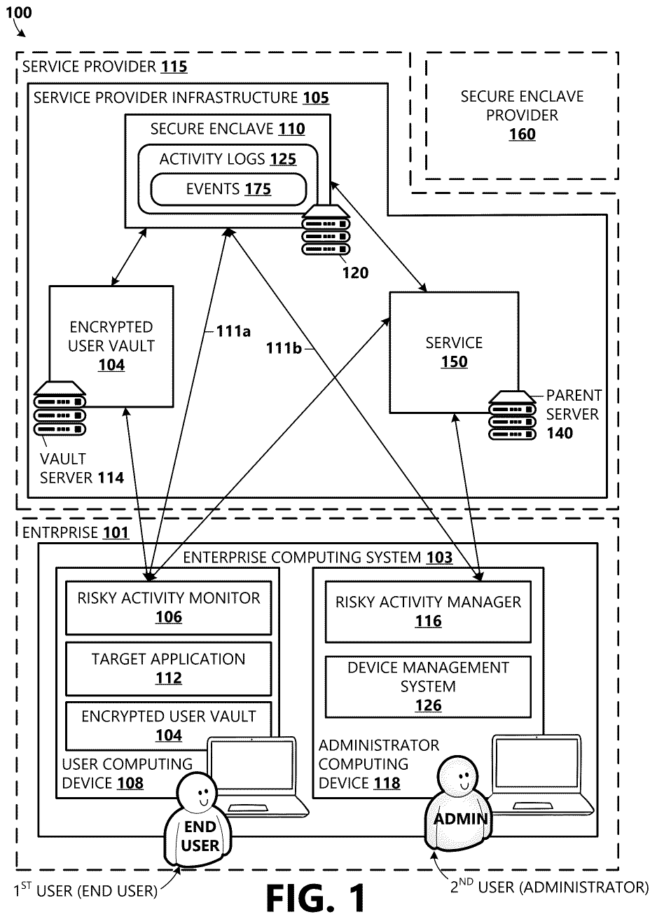

With reference now to FIG. 1, an example system 100 is depicted in which aspects of the present disclosure may be implemented for providing secure and private monitoring of sensitive data in a computing system according to an embodiment. For instance, the system 100 may be used to enable an enterprise 101 (e.g., a business, corporation, organization, educational institution, governmental body, or other type of group entity) to securely and privately monitor user behavior (such as risky web activity) of users that indicate potential security threats or vulnerabilities. The example system 100 includes a service 150 provided to the enterprise 101 by a service provider 115. The service 150 operates on a parent server 140 of a service provider infrastructure 105 and includes one or a combination of services 150 that provide secure management of sensitive user data, such as enterprise-monitored data (e.g., activity logs 125), cryptographic keys, user credentials, files, communications, financial data, health data, etc. For instance, the service 150 may include functionalities of a first service 150, such as a password manager, and functionalities of a second service 150, such as a risky activity monitoring service. In examples, the service 150 is provided in accordance with zero-knowledge principles. That is, sensitive data managed by the service 150 is not accessible to the service provider 115 nor its employees. In some examples, users of the service 150 are provided an encrypted user vault 104 hosted on at least one vault server 114. For instance, the encrypted user vault 104 is a database component (e.g., owned and operated by the service provider 115) that stores user data and is protected by a vault secret known (preferably only) to the user. The vault secret may be used to encrypt the stored user data. The encrypted user vault 104 may be synchronized to one or a plurality of user computing devices 108 using a client application provided by the service provider 115 installed on the user computing devices 108.

The enterprise 101 may represent an entity, such as a business, corporation, organization, educational institution, governmental body, or other group of users of the service 150. In examples, users of the service 150 include employees, students, and/or other affiliates of the enterprise 101 that operate one or more user computing devices 108 and/or administrator computing devices 118 included in the enterprise's computing system 103. The enterprise computing system 103 represents a technological infrastructure managed and operated by the enterprise 101 including a plurality of user computing devices 108, administrator computing devices 118, servers, databases, networks, applications, and/or other digital resources that support the enterprise's operations, services, and/or internal processes. User computing devices 108 and/or administrator computing devices 118 may include desktop computers, laptops, smartphones, tablets, gaming devices, and/or other devices capable of running installed applications and connecting to networks.

According to examples, a user computing device 108 may be operated by a first user representing a regular end user of the service 150 (e.g., an employee of the enterprise 101). As shown, a target application 112 and a risky activity monitor 106 are installed on the user computing device 108. The risky activity monitor 106 is a first client application provided by the service provider 115 that interfaces the target application 112 (e.g., via one or more application programming interfaces (APIs), event listeners, etc.) to capture events 175 of user interactions performed in the target application 112 in an activity log 125. In some implementations, the risky activity monitor 106 is a browser extension and the target application 112 is a web browser application. For instance, the end user may use the web browser to visit websites, online services, etc. In examples, when a predefined risky user behavior (e.g., a defined action that indicates a potential security threat or vulnerability) is determined to have occurred, the risky activity monitor 106 triggers a logging component to capture the risky user behavior (e.g., risky web activity) as an event 175 including metadata about the risky user behavior (e.g., using a weak or compromised password on a website, visiting a malware-infected website, interacting with a phishing link, etc.). In some examples, the metadata includes a user identifier of the end user, an action type, a timestamp, a device identifier of the user computing device 108, a website where the action was performed, and/or additional details about the action. In some examples, the defined actions corresponding to defined risky user behavior captured by events 175 are configurable by the enterprise 101.

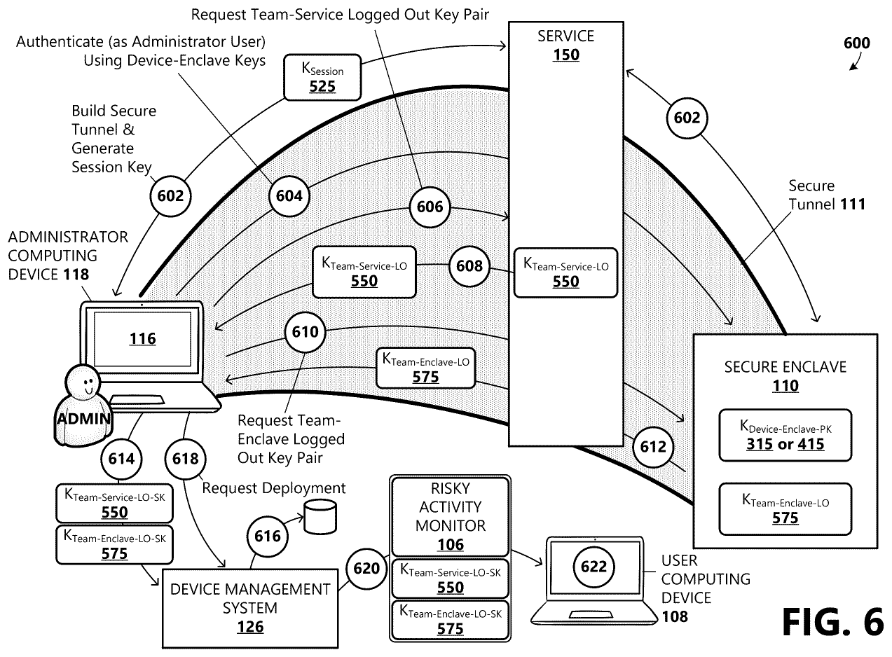

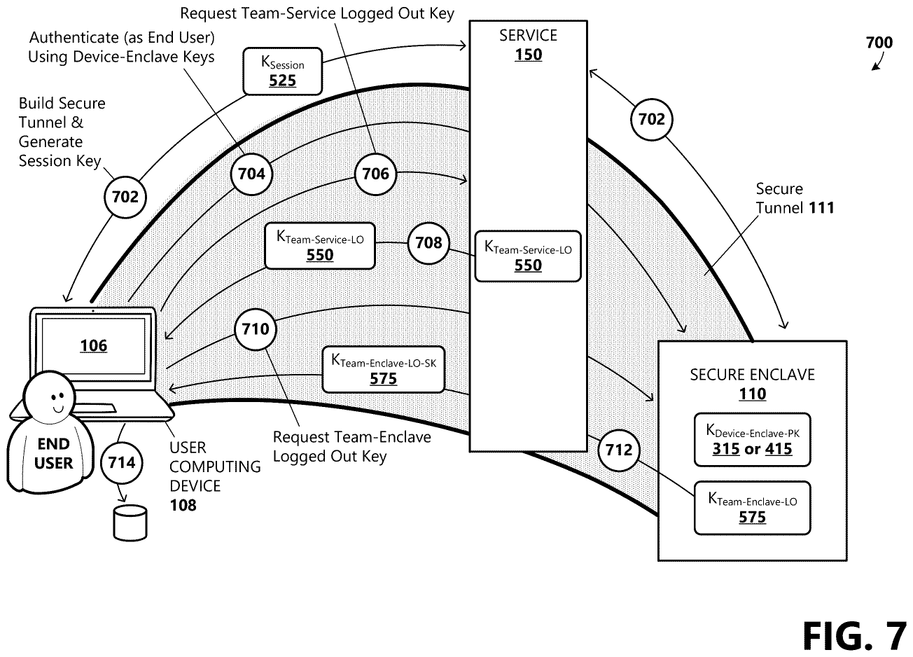

In some implementations, the risky activity monitor 106 may be installed on the user computing device 108 by the end user (as depicted in and described below with reference to FIG. 7). In other implementations, the risky activity monitor 106 is installed on one or a plurality of user computing devices 108 (used by one or a plurality of end users) via an announced or silent mass deployment (as depicted in and described below with reference to FIG. 6). The deployment of the risky activity monitor 106 may be performed by a device management system 126 and initiated by a second user (herein referred to as an administrator) associated with the enterprise 101 (e.g., an IT administrator or other person responsible for helping to protect the enterprise computing system 103 and data). The device management system 126 may operate on an administrator computing device 118. The administrator may be assigned an administrator role that provides the administrator with specific permissions, access, and/or control over the enterprise computing system 103 versus to a normal end user. In some examples, the administrator's administrator role is defined and managed by the enterprise computing system 103 (or a directory service) and shared with the service 150. In other examples, the administrator's administrator role is defined and managed by the service 150.

According to an aspect, the risky activity monitor 106 is configured to send activity logs 125 of risky web activity captured on the user computing device 108 to the secure enclave 110 for storage. In some examples, the risky activity monitor 106 is configured to send activity logs 125 of risky web activity captured on the user computing device 108 whether or not the end user has an account with the service provider 115 or is logged into the service 150. For example, the risky activity monitor 106 may send activity logs 125 for a “logged-in user” (e.g., an end user who is currently logged into the service 150) on the user computing device 108) and for a “logged-out user” (e.g., an end user who is not currently logged into the service 150). In examples, a logged-out user refers to an end user who has previously used and, thus, previously logged into the service 150 on the currently used user computing device 108 or on another user computing device 108, or an end user who has not yet created a user account with the service provider 115 and/or service 150.

The activity logs 125 include sensitive information that may provide visibility of potential security vulnerabilities in the enterprise computing system 103. In some examples, activity logs 125 may include information about a visited domain and/or password strength information, which can be exploited by a malicious actor. For instance, knowledge of common domains used by an enterprise can enable the malicious actor to move laterally through networks after initial compromise and to craft convincing spear phishing emails that target employees with messages appearing to come from trusted sources, which can increase the effectiveness of an attack. Thus, activity logs 125 include information that can be valuable both defensively by the enterprise to fix security vulnerabilities and offensively by a malicious actor to exploit those vulnerabilities. Accordingly, aspects of the system 100 and methods described herein increase security by protecting the activity logs 125 from access by unintended users. The first secure tunnel 111a ensures that only the secure enclave 110 can read messages sent from the risky activity monitor 106. In examples, the secure enclave server 120 is owned and operated by a secure enclave provider 160 that is a separate entity from the service provider 115 of the service 150. The secure enclave 110 may be a hardware-based or software-based isolated environment within the secure enclave server 120, where the secure enclave 110 may be designed to protect sensitive data and execute trusted code in isolation from the main operating system and other applications running on the secure enclave server 120.

According to an aspect, a risky activity manager 116 (e.g., a second client application provided by the service provider 115) is installed on an administrator (or admin) computing device 118 used by the administrator. In examples, the risky activity manager 116 allows the administrator (e.g., based on the administrator's defined administrator role) to securely access activity logs 125 from the secure enclave 110. In some examples, the risky activity monitor 106 and the risky activity manager 116 may be the same client application that offers different functionalities to different users based on the user's role (e.g., an administrator role versus a normal end user role). In other examples, the risky activity monitor 106 and the risky activity manager 116 are different client applications (e.g., configured for different user roles). In some implementations, the risky activity manager 116 is a browser extension. In other implementations, the risky activity manager 116 is a standalone application, a mobile application, or a service integrated into another software platform. In examples, the risky activity manager 116 may provide a user interface via which the administrator may interact with the risky activity manager 116 (e.g., to query activity log data stored in the secure enclave 110). According to an aspect, the service 150 performs operations to establish a second secure end-to-end encrypted channel (referred to herein as a second secure tunnel 111b) between the risky activity manager 116 and the secure enclave 110. The second secure tunnel 111b ensures that only the risky activity manager 116 can read messages sent from the secure enclave 110. In examples, the risky activity manager 116 is configured to access activity logs 125 from the secure enclave 110 via the second secure tunnel 111b.

Sensitive data (e.g., activity logs 125 and/or details of events 175 included in the activity logs 125) sent from the secure enclave 110 is accessible only to a designated user of the service 150 based on the user's defined role (e.g., an administrator role). This may be achieved by an arrangement of cryptographic keys such that activity logs 125 can be decrypted only within the secure enclave 110 (and nowhere else) and by an authentication mechanism that allows only users with an administrator role to access activity log data from the secure enclave 110. Accessing an activity log 125 may include querying or retrieving data from the activity log 125. For example, the risky activity manager 116 may query activity logs 125 generated by one or more risky activity monitors 106 installed on one or more user computing devices 108 for events 175 corresponding to risky web activities (e.g., using a weak or compromised password on a website, visiting a malware-infected website, or interacting with a phishing link). For instance, an IT administrator may access encrypted activity logs 125 in order to monitor their users' web activity for events 175 corresponding to risky web activities that indicate potential security threats or vulnerabilities to the enterprise computing system 103.

In some examples, the risky activity manager 116 presents activity log data in the user interface. In further examples, the risky activity manager 116 is configured to perform an automated action to increase security when a specific risky web activity captured in an activity log 125 is identified. For instance, the risky activity manager 116 may flag the corresponding event 175, query the secure enclave 110 for details about the event 175, provide feedback (e.g., an alert or notification) to the end user and/or the administrator, perform a scan of the user computing device 108, quarantine the user computing device 108 from the enterprise computing system 103, etc. In examples, an alert or notification provided to the end user and/or administrator may include information about the risky web activity performed by the end user and may further include a recommendation to reduce the potential security threat or vulnerability (e.g., a recommendation to change a weak or compromised password and/or use a password manager to securely store and generate a strong password). The feedback may be provided in one or more formats (e.g., via an email, text message, push notification instant message, an in-application notification (presented by a user interface of the risky activity manager 116 and/or risky activity monitor 106), in a dashboard display, and/or via a phone call). In some examples, the feedback includes a link or other selectable option to perform an included recommendation (e.g., a link to a password manager or to the website where a weak or compromised password was used). In further examples, the feedback includes tools to provide coaching to end users whose interactions with the target application 112 are identified as risky web activity. Additional or alternative automated actions are contemplated.

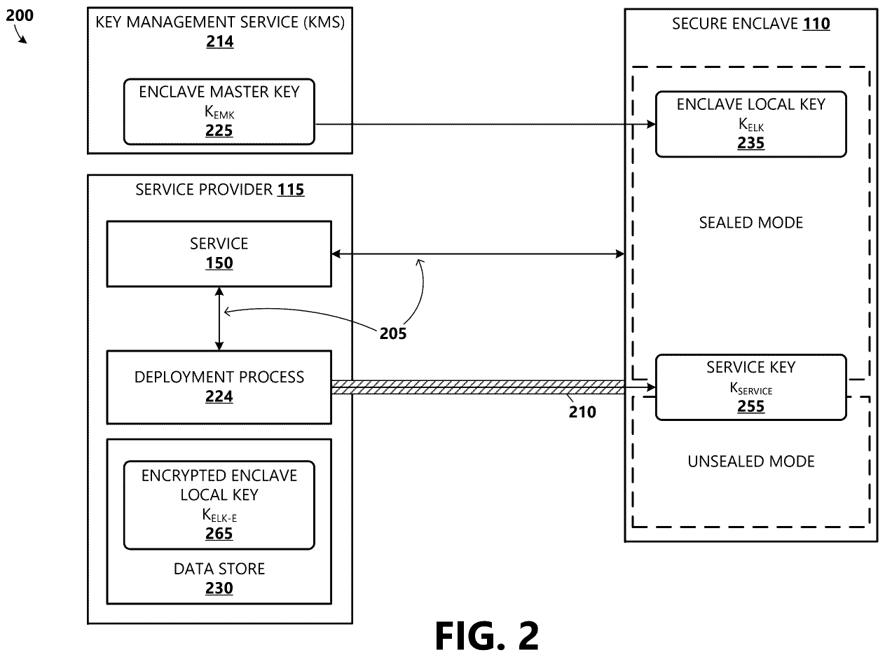

With reference now to FIG. 2, an example method 200 and key arrangement for system initialization is depicted that may be performed for creating a zero-knowledge execution environment for the service 150 to securely store activity logs 125. The example key arrangement includes a first key (e.g., an enclave local key (K_{ELK}) 235) and a second key (e.g., a service key (K_{SERVICE}) 255) used to encrypt a user's authentication keys within the secure enclave 110. The service key (K_{SERVICE}) 255 may be provided by the service provider 115 and the enclave local key (K_{ELK}) 235 may be provided by a key management service (KMS) 214, which is provided by the secure enclave provider 160.

In examples, the secure enclave 110 is not provided with persistent storage; thus, the KMS 214 is utilized to authenticate that requests are coming from a trusted secure enclave for encrypting the storage of the secure enclave 110. For instance, the service provider 115 leverages secure enclave technology to operate an encryption service without being able to access users'encryption keys processed by the encryption service. Availability of the enclave local key (K_{ELK}) 235 may be managed through access policies determined by the service provider 115. According to an aspect, the access policies prevent the enclave local key (K_{ELK}) 235 from being accessible to employees of the service provider 115. According to another aspect, the service key (K_{SERVICE}) 255 may be available to the service provider 115, but it is not available to the secure enclave provider 160. The example key arrangement, authentication of the secure enclave 110 through attestation at runtime, and the secure isolated environment (e.g., the configuration of the secure enclave 110) secures the activity logs 125 from access by the secure enclave provider 160 or the service provider 115. In examples, service provider 115 isolation is accomplished at least in part due to the dependency and inaccessibility of the enclave local key (K_{ELK}) 235, and secure enclave provider 160 isolation is accomplished at least in part due to the dependency and inaccessibility of the service key (K_{SERVICE}) 255.

An example system initialization process for the secure enclave 110 includes generating an enclave master key (K_{EMK}) 225 to encrypt and decrypt the enclave local key (K_{ELK}) 235. In examples, the enclave master key (K_{EMK}) 225 is generated in the KMS 214 and cannot be exported outside the KMS 214. Access policies built into the enclave master key (K_{EMK}) 225 grant access of the enclave local key (K_{ELK}) 235 only to the secure enclave 110. In examples, the access policies are built based on information provided by attestation of the secure enclave 110. For instance, when the KMS 214 receives a request for the enclave master key (K_{EMK}) 225, the attestation provided by the requester is matched against the access policies to grant or deny the request.

In examples, upon generation of the enclave master key (K_{EMK}) 225, the secure enclave 110 is deployed and requests, from the KMS 214, two versions of the enclave local key (K_{ELK}) 235: a first key in plaintext (referred to generally as, the enclave local key (K_{ELK}) 235) and a second key that is encrypted by the enclave master key (K_{EMK}) 225 (referred to as an encrypted enclave local key (K_{ELK-E}) 265). In some examples, the enclave local key (K_{ELK}) 235 is encrypted with an ephemeral public key provided by the secure enclave 110 so that no data is leaked. The enclave local key (K_{ELK}) 235 may be stored (e.g., in plaintext) by the secure enclave 110 in volatile memory (e.g., RAM). Additionally, the secure enclave 110 may request for storage of the encrypted enclave local key (K_{ELK-E}) 265 in a data store 230 of the service provider 115 (e.g., on the parent server 140 or another server in the service provider infrastructure 105). Thus, if the secure enclave 110 reboots or a new instance of the secure enclave 110 is deployed, the new instance can request the encrypted enclave local key (K_{ELK-E}) 265 from storage that the KMS 214 can then decrypt with the enclave master key (K_{EMK}) 225. This way, the secure enclave 110 is provided with the enclave local key (K_{ELK}) 235 to encrypt data, and the encrypted enclave local key (K_{ELK-E}) 265 is never in plaintext outside a secured environment (e.g., the secure enclave 110 or the KMS 214).

In examples, when the secure enclave 110 is instantiated and receives the enclave local key (K_{ELK}) 235, the secure enclave 110 is in a sealed mode 240 and is in condition to receive the service key (K_{SERVICE}) 255 so that it can enter an unsealed mode 245. For instance, in the unsealed mode 245, the secure enclave 110 is in condition to derive a session key (K_{SESSION}) to cipher messages between the secure enclave 110 and a client application (e.g., the risky activity monitor 106 or the risky activity manager 116).

In an example implementation, the service key (K_{SERVICE}) 255 is a symmetric cryptographic key that is stored by the service provider 115 (e.g., in the service provider infrastructure 105) and that is made available to the secure enclave 110 by a deployment process 224 of the secure enclave 110 to unseal the secure enclave 110. For instance, when confirmation is made that the secure enclave 110 is operational, the deployment process 224 initiates the unseal operation. In examples, the service 150 facilitates a handshake operation 205 between the deployment process 224 and the secure enclave 110 to build a secure communication channel 210 via which the service key (K_{SERVICE}) 255 can be passed to secure enclave 110 by the deployment process 224. In examples, the secure enclave 110 provides cryptographic attestation to prove its runtime environment is secure and trustworthy. In some examples, the secure enclave 110 authenticates the deployment process 224 with a secret value generated when the secure enclave 110 is initialized. This way, the deployment process 224 may pass the secret value with the service key (K_{SERVICE}) 255 through the secure communication channel 210 to the secure enclave 110 to prove to the secure enclave 110 that the service key (K_{SERVICE}) 255 is the correct unseal key. The service provider 115 may manage the service key (K_{SERVICE}) 255 following industry standards for key management. For example, the service key (K_{SERVICE}) 255 may be stored in a different KMS than the KMS 214 of the secure enclave provider 160, and strict access policies may be implemented to deny access to the service key (K_{SERVICE}) 255 to anyone but the deployment process 224. In examples, those access policies may be based on secrets already shared to the deployment process 224 or based on a secret provided by the environment of the deployment process 224 (e.g., federation of identity).

According to an aspect, highly sensitive data may be transmitted between the secure enclave 110 and the risky activity monitor 106 and risky activity manager 116. For instance, activity logs 125 sent to the secure enclave 110 need to be secured for access by only the end user or administrator. Thus, the first secure tunnel 111a and the second secure tunnel 111b (collectively, secure tunnels 111) are established to create a channel via which confidentiality and integrity are ensured when the risky activity monitor 106 or the risky activity manager 116 communicate with the secure enclave 110. An example method of building a secure tunnel 111 between the secure enclave 110 and the risky activity monitor 106 or risky activity manager 116 includes leveraging attestation (e.g., a cryptographic signature of the identity of the secure enclave 110 and additional data) of the secure enclave 110 that the end user or administrator can trust as coming from the declared secure enclave 110. In examples, the end user or administrator is thereby assured that everything sent or received through the secure tunnel 111 can be read only by themself or the secure enclave 110. For instance, the risky activity monitor 106 or risky activity manager 116 may generate client cryptographic primitives (e.g., a public client key (K_{CLIENT-PK}) and a secret client key (K_{CLIENT-SK})) to perform a key exchange with the secure enclave 110. The public client key (K_{CLIENT-PK}) is sent to the secure enclave 110, where the secure enclave 110 then generates server cryptographic primitives (e.g., a public server key (K_{SERVER-PK}) and a secret server key (K_{SERVER-SK})). The secure enclave 110 further generates session keys (Kₛₑₛₛᵢₒₙ) using the public client key (K_{CLIENT-PK}) and the secret server key (K_{SERVER-SK}) to cipher following messages. Additionally, the secure enclave 110 generates an attestation that includes Platform Configuration Registers (PCRs) and the secure enclave's public server key (K_{SERVER-PK}). The secure enclave 110 may then send the attestation and the public server key (K_{SERVER-PK}) to the risky activity monitor 106 or risky activity manager 116 for verification.

The risky activity monitor 106 or risky activity manager 116 may verify the attestation via a chain of trust and PCRs. For instance, PCRs in a Trusted Platform Module (TPM) may be used to store hash values that represent the integrity of different system components for establishing and verifying the trustworthiness of the boot process and configuration of the secure enclave 110. The risky activity monitor 106 or risky activity manager 116 further extracts the public server key (K_{SERVER-PK}) from the attestation and generates session keys (K_{SESSION}) using the secret client key (K_{CLIENT-SK}) and the public server key (K_{SERVER-PK}) to cipher following messages. At this point, the risky activity monitor 106 or risky activity manager 116 and the secure enclave 110 may exchange data by encrypting and authenticating with the session keys (K_{SESSION}), where the risky activity monitor 106 or risky activity manager 116 has authenticated the secure enclave 110 with which it is communicating. However, the secure enclave 110 has not yet authenticated the client.

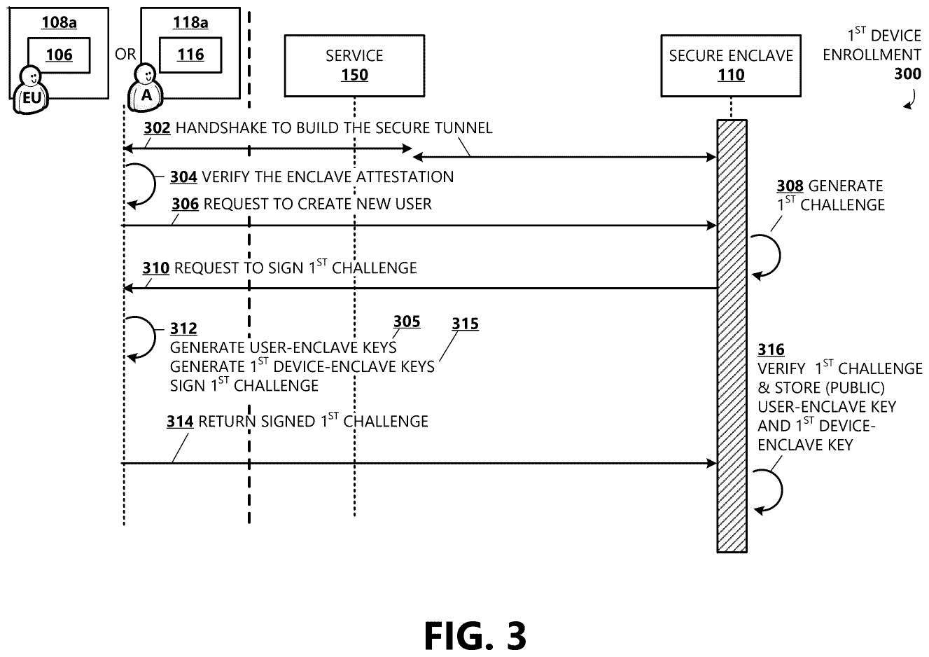

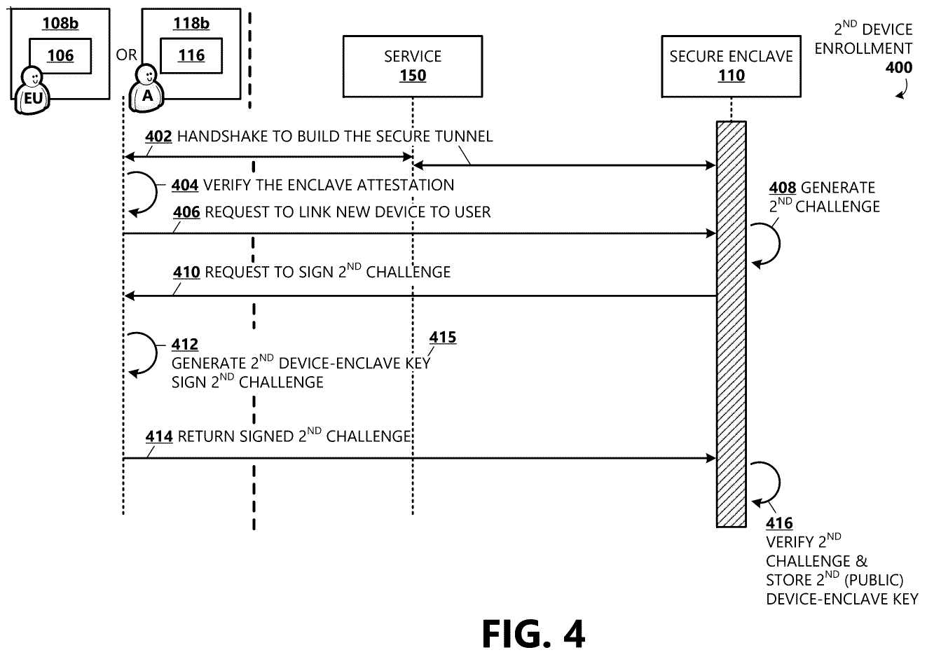

In examples where the risky activity monitor 106 is being used to send an activity log 125 of a logged-in user from a user computing device 108 to the secure enclave 110, the end user may be required to authenticate on the secure enclave 110 though the secure tunnel 111. Or, in examples where the risky activity manager 116 is operating on an administrator computing device 118 and being used by an administrator to access an activity log 125 from the secure enclave 110, the administrator may be required to authenticate on the secure enclave 110 though the secure tunnel 111. The user authentication (and the role of the user) is based on a challenge verified by a public key of an asymmetric device-enclave key pair (K_{Device-Enclave}) attributed to the user. In examples, the secret device-enclave key (K_{Device-Enclave-SK}) of the key pair is stored on the user computing device 108 or the administrator computing device 118 and the public device-enclave key (K_{Device-Enclave-PK}) is sent to the secure enclave 110 during enrollment of the user computing device 108 or the administrator computing device 118 as a trusted device. For instance, the public device-enclave key (K_{Device-Enclave-PK}) is used by the secure enclave 110 verify signatures and authenticate the user. In examples where the user uses a plurality of computing devices (e.g., user computing devices 108 or administrator computing devices 118) to access the secure enclave 110, a unique public device-enclave key (K_{Device-Enclave-PK}) corresponding to each computing device is provided to the secure enclave 110 and linked to the user. Example methods 300 and 400 of enrolling a trusted device for an end user or an administrator are depicted in FIG. 3 and FIG. 4.

With reference now to FIG. 3, an example method 300 of enrolling a first trusted device (e.g., a first user computing device 108a or first administrator computing device 118a) for a user (e.g., an end user or an administrator) is depicted. In examples, operations represented in FIG. 3 may be performed at a first connection/login for the user. At operation 302, a handshake operation as described above may be performed, where the service 150 routes calls between the secure enclave 110 and the risky activity monitor 106 or risky activity manager 116 operating on the first user computing device 108a or first administrator computing device 118a to build a secure tunnel 111. In examples, in the handshake operation, the secure enclave 110 may send an attestation and the public server key (K_{SERVER-PK}) to the risky activity monitor 106 or risky activity manager 116 for verification.

At operation 304, attestation provided by the secure enclave 110 may be verified and session keys (K_{SESSION}) may be generated by the risky activity monitor 106 or risky activity manager 116 using a secret client key (K_{CLIENT-SK}) and a public server key (K_{SERVER-PK}) provided by the secure enclave 110 with the attestation. At this point, the risky activity monitor 106 or the risky activity manager 116 and the secure enclave 110 may exchange data by encrypting and authenticating with the session keys (K_{SESSION}), where the risky activity monitor 106 or the risky activity manager 116 has authenticated the secure enclave 110 with which it is communicating.

At operation 306, a request for creating a new user account is sent from the risky activity monitor 106 or the risky activity manager 116 to the secure enclave 110 via the secure tunnel 111.

At operation 308, a first challenge may be generated by the secure enclave 110 and, at operation 310, a request is sent to the first user computing device 108a or first administrator computing device 118a to sign the first challenge. In some examples, the first user computing device 108a or first administrator computing device 118a is automatically enrolled as a trusted device (i.e., Trust On First Use). In other examples, a code (e.g., a One-time Passcode (OTP)) is sent to the user (e.g., via email, a text message, or via another method) to verify the user's identity.

In some examples, at operation 312, the risky activity monitor 106 or the risky activity manager 116 generates a user-enclave key pair (K_{User-Enclave}) 305 (e.g., as an enrollment key) and a first device-enclave key pair (K_{Device-Enclave}) 315 in response to the request. The risky activity monitor 106 or the risky activity manager 116 may further sign the first challenge with the secret keys of the user-enclave key pair (K_{User-Enclave-SK}) 305 and the first device-enclave key pair (K_{Device-Enclave}) 315. In other examples, a user-enclave key is not implemented and, at operation 312, the risky activity monitor 106 or the risky activity manager 116 generates only the first device-enclave key pair (K_{Device-Enclave}) 315 and signs the first challenge with the secret key of the first device-enclave key pair (K_{Device-Enclave-SK}) 315.

The secret key of the first device-enclave key pair (K_{Device-Enclave-SK}) 315 is stored locally on the first user computing device 108a or first administrator computing device 118a. For instance, the first device-enclave secret key is used to authenticate the client side of secure tunnels 111 with the secure enclave 110 so that activity logs 125 can be transmitted to and from the secure enclave 110 securely. The secret key of the user-enclave key pair (K_{User-Enclave-SK}) 305 (if implemented) may be kept by the user. In some examples, such as where the service 150 includes a password manager, the user-enclave secret key (K_{User-Enclave-SK}) 305 may be encrypted and stored in the encrypted user vault 104. For instance, the user-enclave secret key (K_{User-Enclave-SK}) 305 may be made available on any user computing device 108 or administrator computing device 118 running the risky activity monitor 106, risky activity manager 116, or another client application in communication with the service 150 that is configured to receive an input of the user's vault secret to decrypt the user-enclave secret key (K_{User-Enclave-SK}) 305. For instance, the user-enclave secret key (K_{User-Enclave-SK}) 305 may be used to authenticate the client side when enrolling a new trusted device.

At operation 314, the risky activity monitor 106 or the risky activity manager 116 sends a response to the secure enclave 110 via the secure tunnel 111 including the signed first challenge and the public keys of the generated key pairs (e.g., the first device-enclave public key (K_{Device-Enclave-PK}) 315 and, in some examples, the user-enclave public key (K_{User-Enclave-PK}) 305). In examples where an OTP code is sent to the user to verify their identity, the OTP code may additionally be included in the response (or in a separate communication to the secure enclave 110 for verification).

At operation 316, the signed first challenge may be verified by the secure enclave 110 using the one or more public keys (e.g., the first device-enclave public key (K_{Device-Enclave-PK}) 315 and, in some examples, the user-enclave public key (K_{User-Enclave-PK}) 305). In examples where the code is sent to the user, the code may also be verified. Upon verification of the first challenge (and the OTP code), the end user or administrator is assigned a user ID and registered as a new user. When the user-enclave key (K_{User-Enclave}) 305 is implemented, the user-enclave public key (K_{User-Enclave-PK}) 305 may be linked to a user identifier (ID) of the new user.

In examples, a device ID may be created and associated to the first user computing device 108a or first administrator computing device 118a and the public key of the first device-enclave key pair (K_{Device-Enclave-PK}) 315. Further, the device ID is linked to the user's user ID. The one or more public keys (e.g., the first device-enclave public key (K_{Device-Enclave-PK}) 315 and, in some examples, the user-enclave public key (K_{User-Enclave-PK}) 305) are stored in association with the device ID and user ID a public key directory. In some examples, the secure enclave 110 requests the service 150 to provide storage for the public key directory. The public keys may be protected in integrity at rest by the secure enclave 110 by employing a Message Authentication Code (MAC) algorithm based on the enclave local key (K_{ELK}) 235 and the service key (K_{SERVICE}) 255.

In examples, the secure enclave 110 stores additional user data that is linked to the user ID, such as the role of the enrolled user. Thus, the secure enclave 110 can determine whether the user is a normal end user (e.g., an employee) or an administrator. The user's role data may also be protected from being tampered with by employing a MAC algorithm based on the enclave local key (K_{ELK}) 235 and the service key (K_{SERVICE}) 255.

In examples, the secure enclave 110 may be configured as the only entity that may modify the public keys of the first device-enclave key pair (K_{Device-Enclave-PK}) 315 and the user-enclave key pair (K_{User-Enclave-PK}) 305) based on following implemented policies within the secure enclave 110. In some examples, a malicious actor may be prevented from creating or modifying an item on behalf of the secure enclave 110, but not from deleting an item. In some Trust-On-First-Use (TOFU) scenarios, this may allow the malicious actor to spoof a user's identity. In present examples, this may be prevented by building the integrity and guaranteeing the whole public key directory (e.g., versus guaranteeing only item per item in the public key directory). This way, the removal of an item performed by an entity other than the secure enclave 110 would be detected by the secure enclave 110 and would prevent further compromise of the system.

In some implementations, the integrity of the public key directory may be based on a structure of cryptographic hashes of items belonging to the directory. In one implementation, the secure enclave 110 computes the hash of the concatenation of every item in the public key directory for every change of the directory. The computed hash may be stored in the secure enclave's memory and checked for every storage access of the secure enclave 110. In other implementations, the structure of hashes may be a hash list, a hash chain, or a hash tree (Merkle Tree), and the secure enclave 110 may store a value representing the state of the public key directory (e.g., a “directory root hash”). In examples, the secure enclave 110 may check the integrity of the whole public key directory against the directory root hash upon storage access.

In examples, the secure enclave 110 may be able to verify the integrity of the public key directory as long as the secure enclave 110 is operating and keeps the directory root hash in its volatile memory. If a reboot of the secure enclave 110 occurs, the secure enclave 110 may need to get the directory root hash back in a trustworthy manner to detect illegitimate changes in the public key directory. In some examples, the directory root hash is computed based on a secret known only by the secure enclave 110. This secret may be a random key encrypted at rest and/or derived by/from either the enclave local key (K_{ELK}) 235, the enclave master key (K_{EMK}) 225, or by a combination of the enclave local key (K_{ELK}) 235 and the unseal key (e.g., the service key (K_{SERVICE}) 255).

In some examples, the directory root hash is created using a MAC. For instance, the MAC may be generated using a Verifiable Random Function (VRF), a family of functions generating pseudo random values from a secret key, and with a public key to verify the correct generation from the secret key. This way, the secure enclave 110 may be the only entity able to compute a legitimate directory root hash. Further, the secure enclave 110 is able to verify the directory root hash from the storage while the secure enclave 110 in case of a reboot.

In examples, being able to verify the legitimacy of a directory root hash prevents anyone but the secure enclave 110 from computing a directory root hash but may not prevent a rollback of the directory root hash to a past value. In some attacks, a malicious actor may trigger the reboot of the secure enclave 110 while reverting the public key directory and the directory root hash at rest into a past state. For instance, the malicious actor may attempt to abuse the TOFU model. Examples of the present disclosure may prevent a malicious rollback by storing the directory root hash in an append-only storage. For example, when the secure enclave 110 reboots, the secure enclave 110 may read the whole append-only storage to check that no rollback has occurred. If the directory root hash received at boot time is not the last directory root hash in the append-only storage, the secure enclave 110 may fail to start. The secure enclave 110 may also be configured to fail to start if a same directory root hash appears more than once in the append-only storage. In some examples, the append-only storage is based on a public append-only structure, such as blockchains or Certificate Transparency. For instance, present systems and methods may use implementations of key transparency protocols to provide the discussed security properties.

In examples, the system 100 described herein is reinforced with a notification and audit system to ensure information and feedback regarding the system use is available to a user for scrutiny. For instance, particular events may trigger a notification and be added to an audit log for analysis, such as a new device registration (e.g., enrollment) with secure enclave 110, change of a role of a user, a modification on a distribution list for such notification system, etc. In examples, a notification may be delivered in real-time or near real-time to the user (e.g., an end user and/or an administrator) and may be configurable. According to an aspect, notifications may only be triggered from events that occur within the secure enclave 110, thus ensuring only legitimate events are logged or notified.

With reference now to FIG. 4, an example method 400 of enrolling a second trusted device (e.g., a second user computing device 108b or second administrator computing device 118b) for the user (e.g., end user or administrator) is depicted. At operation 402, a handshake operation as described above may be performed, where the service 150 routes calls between the secure enclave 110 and the risky activity monitor 106 or risky activity manager 116 operating on the second user computing device 108b or second administrator computing device 118b to build a secure tunnel 111. In examples, in the handshake operation, the secure enclave 110 may send an attestation and the public server key (K_{SERVER-PK}) to the risky activity monitor 106 or risky activity manager 116 for verification.

At operation 404, attestation provided by the secure enclave 110 may be verified and session keys (K_{SESSION}) may be generated by the risky activity monitor 106 or risky activity manager 116 using a secret client key (K_{CLIENT-SK}) and a public server key (K_{SERVER-PK}) provided by the secure enclave 110 with the attestation. The session keys (K_{SESSION}) may be used to cipher following messages between the secure enclave 110 and the risky activity monitor 106 or risky activity manager 116.

At operation 406, a request for linking a new device to the user is sent from the risky activity monitor 106 or the risky activity manager 116 to the secure enclave 110 via the secure tunnel 111.

At operation 408, a second challenge may be generated by the secure enclave 110 and, at operation 410, a request is sent to the second user computing device 108b or second administrator computing device 118b to sign the second challenge.

In examples where user-enclave keys (K_{User-Enclave}) 305 are implemented, at operation 412, the risky activity monitor 106 or the risky activity manager 116 generates a second device-enclave key pair (K_{Device-Enclave}) 415 and signs the second challenge and the public key of the second device-enclave key pair (K_{Device-Enclave-PK}) 415 with the user-enclave secret key (K_{User-Enclave-SK}) 305 in response to the request. In examples where user-enclave keys (K_{User-Enclave}) 305 are not implemented, at operation 412, the risky activity monitor 106 or the risky activity manager 116 generates the second device-enclave key pair (K_{Device-Enclave}) 415 and signs the second challenge and the public key of the second device-enclave key pair (K_{Device-Enclave-PK}) 415 with the secret key of the second device-enclave key pair (K_{Device-Enclave-SK}) 415. The secret key of the second device-enclave key pair (K_{Device-Enclave-SK}) 315 is stored locally on the second user computing device 108b or second administrator computing device 118b. The secret keys are used to authenticate the client side of secure tunnels 111 with the secure enclave 110. For instance, the first device-enclave secret key is used to authenticate the client side of secure tunnels 111 with the secure enclave 110 so that activity logs 125 can be transmitted to and from the secure enclave 110 securely.

At operation 414, the risky activity monitor 106 or the risky activity manager 116 sends a response to the secure enclave 110 via the secure tunnel 111 including the signed second challenge and the second device-enclave public key (K_{Device-Enclave-PK}) 415.

At operation 416, the signed second challenge may be verified by the secure enclave 110. In examples where user-enclave keys (K_{User-Enclave}) 305 are implemented, the signature of the second challenge may be verified using the public keys of the user-enclave key pair (K_{User-Enclave-PK}) 305 and the second device-enclave key pair (K_{Device-Enclave-PK}) 415. Alternatively, in examples where user-enclave keys (K_{User-Enclave}) 305 are not implemented, the secure enclave 110 may verify the signature of the second challenge with the second device-enclave public key (K_{Device-Enclave-PK}) 415 and further request a response from the user (e.g., the end user or the administrator) via the user's already trusted device (e.g., an enrolled first user computing device 108a or enrolled first administrator computing device 118a) to authenticate the user. For instance, the secure enclave 110 may send a request to the user to perform a check of the second device-enclave public key (K_{Device-Enclave-PK}) 415 via the first user computing device 108a or first administrator computing device 118a. In examples, the user may verify the request to link the second user computing device 108b or second administrator computing device 118b to their user account. The risky activity monitor 106 or the risky activity manager 116 may then sign the second device-enclave public key (K_{Device-Enclave-PK}) 415 with the first device-enclave public key (K_{Device-Enclave-PK}) 315 stored locally on the first user computing device 108a or first administrator computing device 118a and then send the signed second device-enclave public key (K_{Device-Enclave-PK}) 415 to the secure enclave 110. The secure enclave 110 may then verify the signature of the second device-enclave public key (K_{Device-Enclave-PK}) 415 with the first device-enclave public key (K_{Device-Enclave-PK}) 315. Upon verification of the signature of the second challenge and the signature of the second device-enclave public key (K_{Device-Enclave-PK}) 415, a device ID may be created and associated to the second user computing device 108b or second administrator computing device 118b and linked to the user's user ID.

In some examples, the secure enclave 110 requests the service 150 to provide storage for the the second device-enclave public key (K_{Device-Enclave-PK}) 415, where the second device-enclave public key (K_{Device-Enclave-PK}) 415 may be protected in integrity at rest by the secure enclave 110 by performing a Message Authentication Code (MAC) algorithm based on the enclave local key (K_{ELK}) 235 and the service key (K_{SERVICE}) 255.

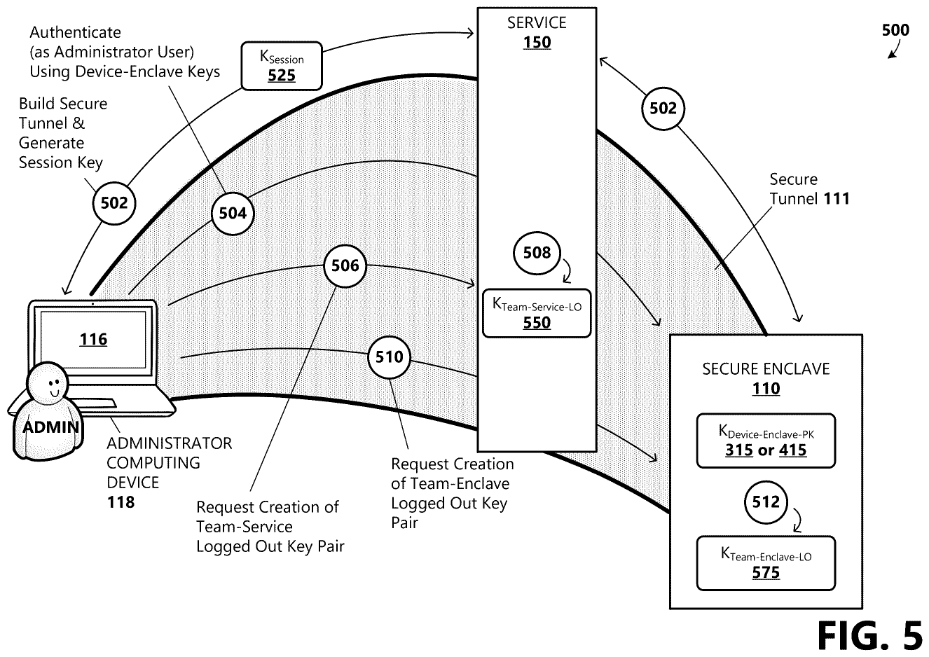

As mentioned above, the risky activity monitor 106 is configured to generate and send activity logs 125 of risky web activity of logged-out users. In such examples, the risky activity monitor 106 may be required to authenticate to the service provider 115 and to the secure enclave 110 using team logged-out keys. An example method 500 of generating a team-service logged-out key pair (K_{Team-Service-LO}) and a team-enclave logged-out key pair (K_{Team-Enclave-LO}) is depicted in FIG. 5. Example methods 600 and 700 of deploying the secret keys of the key pairs (K_{Team-Service-LO-PK}) and (K_{Team-Enclave-LO-PK}) are depicted in FIGS. 6 and 7 and are described below.

With reference now to FIG. 5, the example method 500 may be performed when the administrator sets up the service 150 for the first time for the entity computing system 103. At operation 502, a secure tunnel 111 is established between an administrator computing device 118 and the secure enclave 110. For instance, a handshake operation as described above may be performed, where the service 150 routes calls between the risky activity manager 116 operating on the administrator computing device 118 and the secure enclave 110 to build the secure tunnel 111. In examples, the service 150 handles an exchange of an attestation provided by the secure enclave 110 that may be verified by the risky activity manager 116. Upon verification, session keys (K_{SESSION}) 525 may be generated by the risky activity manager 116 using a secret client key (K_{CLIENT-SK}) and a public server key (K_{SERVER-PK}) provided by the secure enclave 110 with the attestation. Following messages between the risky activity manager 116 and the secure enclave 110 may be ciphered using the session keys (K_{SESSION}) 525.

At operation 504, the administrator (and their role) may be authenticated by the secure enclave 110 using the device-enclave key pair (K_{Device-Enclave}) 315 or 415 (e.g., generated using method 300 or method 400 described above). For instance, the risky activity manager 116 may use the device-enclave secret key (K_{Device-Enclave-SK}) 315 or 415 to sign a challenge sent by the secure enclave 110 and the device-enclave public key (K_{Device-Enclave-PK}) 315 may be used by the secure enclave 110 to verify the signature. The service 150 may handle the exchange of the challenge.

At operation 506, a first request (from the risky activity manager 116) may be received by the service 150 to create a team-service logged-out key pair (K_{Team-Service-LO}) 550. In response to the first request, the team-service logged-out key pair (K_{Team-Service-LO}) 550 is created by the service 150 at operation 508. In examples, the public key and the secret key of the team-service logged-out key pair (K_{Team-Service-LO}) 550 may be stored by the service 150 (e.g., on the parent server 140 or another server in the service provider infrastructure 105).

At operation 510, a second request from the risky activity manager 116 may be received and passed to the secure enclave 110 to create a team-enclave logged-out key pair (K_{Team-Enclave-LO}) 575. In response to the second request, the secure enclave 110 creates the team-enclave logged-out key pair (K_{Team-Enclave-LO}) 575. In examples, the public key and the secret key of the team-enclave logged-out key pair (K_{Team-Enclave-LO}) 575 may be stored within the secure enclave 110.

With reference now to FIG. 6, an example method 600 of deploying the secret keys of the team-service logged-out key pair (K_{Team-Service-LO}) 550 and the team-enclave logged-out key pair (K_{Team-Enclave-LO}) 575 to a user computing device 108 is depicted. In the example method 600, the risky activity monitor 106 and secret keys are deployed to one or a plurality of user computing devices 108 (e.g., operated by one or a plurality of end users). For instance, the risky activity monitor 106 may be deployed to a plurality of user computing devices 108 in a mass deployment by an administrator.

At operation 602, a secure tunnel 111 is established between an administrator computing device 118 and the secure enclave 110. For instance, a handshake operation as described above may be performed, where the service 150 routes calls between the risky activity manager 116 operating on the administrator computing device 118 and the secure enclave 110 to build the secure tunnel 111. In examples, the service 150 handles an exchange of an attestation provided by the secure enclave 110 that may be verified by the risky activity manager 116. Upon verification, session keys (K_{SESSION}) 525 may be generated by the risky activity manager 116 using a secret client key (K_{CLIENT-SK}) and a public server key (K_{SERVER-PK}) provided by the secure enclave 110 with the attestation. Following messages between the risky activity manager 116 and the secure enclave 110 may be ciphered using the session keys (K_{SESSION}) 525.

At operation 604, the administrator (and their role) may be authenticated by the secure enclave 110 using the device-enclave keys (K_{Device-Enclave}) 315 or 415 (e.g., generated using method 300 or method 400 described above). For instance, the risky activity manager 116 may use the device-enclave secret key (K_{Device-Enclave-SK}) 315 or 415 to sign a challenge sent by the secure enclave 110 and the device-enclave public key (K_{Device-Enclave-PK}) 315 may be used by the secure enclave 110 to verify the signature. The service 150 may handle the exchange of the challenge.

At operation 606, a first request may be received from the risky activity manager 116 by the service 150 for the team-service logged-out key pair (K_{Team-Service-LO}) 550. In response to the first request, the team-service logged-out key pair (K_{Team-Service-LO}) 550 may be retrieved by the service 150 and sent to the risky activity manager 116 via the secure tunnel 111 at operation 608.

At operation 610, a second request may be received from the risky activity manager 116 and passed to the secure enclave 110 for the team-enclave logged-out key pair (K_{Team-Enclave-LO}) 575. In response to the second request, the secure enclave 110 retrieves and sends the team-enclave logged-out key pair (K_{Team-Enclave-LO}) 575 to the risky activity manager 116 via the secure tunnel 111 at operation 612. For instance, the service 150 may securely route the team-enclave logged-out key pair (K_{Team-Enclave-LO}) 575 to the risky activity manager 116.

At operation 614, the secret keys of the team-service logged-out key pair (K_{Team-Service-LO-SK}) 550 and the team-enclave logged-out key pair (K_{Team-Enclave-LO-SK}) 575 may be provided to the device management system 126. The device management system 126 may operate on a same or different administrator computing device 118 than the device on which the risky activity manager 116 operates.

At operation 616, the team-service logged-out secret key (K_{Team-Service-LO-SK}) 550 and the team-enclave logged-out secret key (K_{Team-Enclave-LO-SK}) 575 may be stored by the device management system 126.

At operation 618, a request may be provided to the device management system 126 to deploy the team-service logged-out secret key (K_{Team-Service-LO-SK}) 550 and team-enclave logged-out secret key (K_{Team-Enclave-LO-SK}) 575 to one or more user computing devices 108.

At operation 620, the device management system 126 may connect to the one or more user computing devices 108 and deploy the risky activity monitor 106, the team-service logged-out secret key (K_{Team-Service-LO-SK}) 550, and team-enclave logged-out secret key (K_{Team-Enclave-LO-SK}) 575 to the one or more user computing devices 108.

At operation 622, the risky activity monitor 106 is installed on the one or more user computing devices 108. Upon installation of the risky activity monitor 106, the team-service logged-out secret key (K_{Team-Service-LO-SK}) 550 and team-enclave logged-out secret key (K_{Team-Enclave-LO-SK}) 575 are read by the risky activity monitor 106 and stored locally on the one or more user computing devices 108.

In some examples, a user ID, such as the user's email or a username of the end user, is provided by the device management system 126 to the corresponding one or more user computing devices 108. The user ID may be received and stored locally by the risky activity monitor 106. For instance, the user ID may be accessed from local storage and read by the risky activity monitor 106 when the team-service logged-out secret key (K_{Team-Service-LO-SK}) 550 and team-enclave logged-out secret key (K_{Team-Enclave-LO-SK}) 575 are used to send an activity log 125. The risky activity monitor 106 may link the user ID to the activity log 125 so that the end user associated with any logged risky web activity can be identified.

At the end of the method 600, the risky activity monitor 106 may be configured to generate and send activity logs 125 and to use the team-service logged-out secret key (K_{Team-Service-LO-SK}) 550 and team-enclave logged-out secret key (K_{Team-Enclave-LO-SK}) 575 to send the activity logs 125 to the secure enclave 110 when the end user is not logged into the service 150. For instance, the risky activity monitor 106 may be configured to generate and send activity logs 125 when risky activities are performed in a target application 112, even in cases where the end user of the user computing device 108 on which the risky activity monitor 106 is installed has never created a user account with the service 150 or service provider 105.

In some implementations, the risky activity monitor 106 may be installed onto the user computing device 108 by the end user. In such cases, the team-service logged-out secret key (K_{Team-Service-LO-SK}) 550 and team-enclave logged-out secret key (K_{Team-Enclave-LO-SK}) 575 may need to be retrieved and stored. An example method 700 of retrieving and storing team logged-out keys is depicted in FIG. 7. For instance, method 700 may be performed in association with the end user logging into the service 150 to retrieve the team logged-out keys.

At operation 702, a secure tunnel 111 is established between the user computing device 108 and the secure enclave 110. For instance, a handshake operation as described above may be performed, where the service 150 routes calls between the risky activity monitor 106 operating on the user computing device 108 and the secure enclave 110 to build the secure tunnel 111. In examples, the service 150 handles an exchange of an attestation provided by the secure enclave 110 that may be verified by the risky activity monitor 106. Upon verification, session keys (K_{SESSION}) 525 may be generated by the risky activity monitor 106 using a secret client key (K_{CLIENT-SK}) and a public server key (K_{SERVER-PK}) provided by the secure enclave 110 with the attestation. Following messages between the risky activity monitor 106 and the secure enclave 110 may be ciphered using the session keys (K_{SESSION}) 525.

At operation 704, the end user (and their normal end user role) may be authenticated by the secure enclave 110 using the device-enclave key pair (K_{Device-Enclave}) 315 or 415 (e.g., generated using method 300 or method 400 described above). For instance, the risky activity monitor 106 may use the device-enclave secret key (K_{Device-Enclave-SK}) 315 or 415 to sign a challenge sent by the secure enclave 110 and the device-enclave public key (K_{Device-Enclave-PK}) 315 may be used by the secure enclave 110 to verify the signature. The service 150 may handle the exchange of the challenge.

At operation 706, a first request from the risky activity monitor 106 may be received by the service 150 for a team-service logged-out key (K_{Team-Service-LO}) 550. In response to the first request, the team-service logged-out key pair (K_{Team-Service-LO}) 550 may be retrieved by the service 150 and passed to the risky activity monitor 106 via the secure tunnel 111 at operation 708.

At operation 710, a second request for the secret key of the team-enclave logged-out key pair (K_{Team-Enclave-LO-SK}) 575 may be proxied from the risky activity monitor 106 to the secure enclave 110. In response to the second request, the secure enclave 110 retrieves and sends the team-enclave logged-out secret key (K_{Team-Enclave-LO-SK}) 575 to the risky activity monitor 106 via the secure tunnel 111 at operation 712. For instance, the service 150 may securely route the team-enclave logged-out secret key (K_{Team-Enclave-LO-SK}) 575 to the risky activity monitor 106.

At operation 714, the team-service logged-out key pair (K_{Team-Service-LO}) 550 and the team-enclave logged-out secret key (K_{Team-Enclave-LO-SK}) 575 may be stored locally on the user computing device 108. At the end of the method 700, the risky activity monitor 106 may be configured to generate and send activity logs 125 and to use the team-service logged-out secret key (K_{Team-Service-LO-SK}) 550 and team-enclave logged-out secret key (K_{Team-Enclave-LO-SK}) 575 to send the activity logs 125 to the secure enclave 110 when the end user is not logged into the service 150.

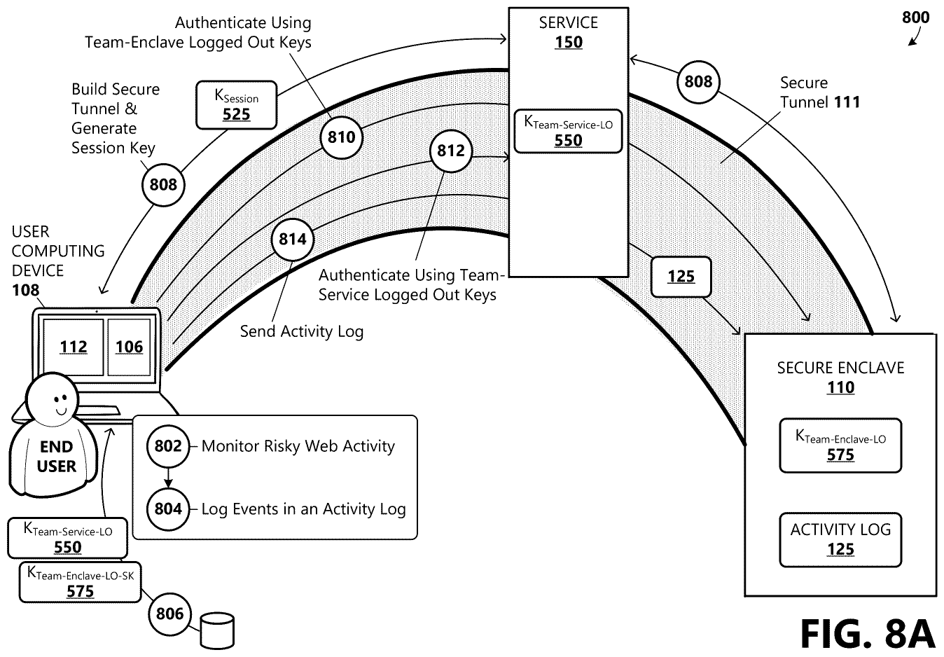

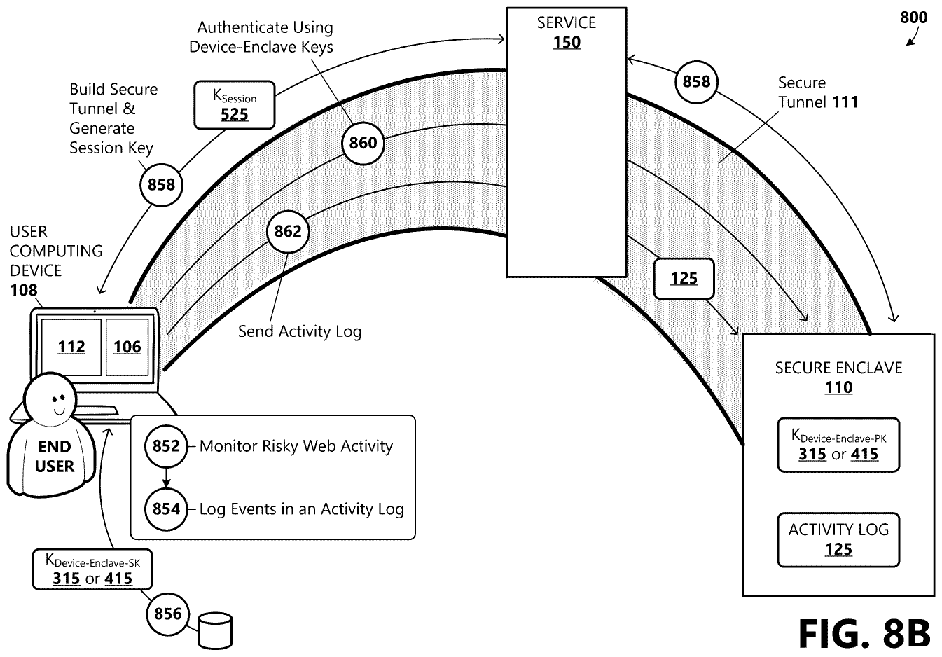

According to an aspect, systems and methods of the present disclosure enable the monitoring of risky web activity of an end user, whether the end user is logged into the service 150 or not logged in. With reference now to FIG. 8A, an example method 800 of securely and privately monitoring risky web activity on a user computing device 108 when the end user is a logged-out user is depicted. In examples, the example method 800 may be performed after method 500 has been performed to create the team-service logged-out key pair (K_{Team-Service-LO}) 550 and the team-enclave logged-out key pair (K_{Team-Enclave-LO}) 575. Additionally, method 800 may be performed after method 600 or method 700 has been performed to provide the user computing device 108 with the team-service logged-out secret key (K_{Team-Service-LO-SK}) 550 and the team-enclave logged-out secret key (K_{Team-Enclave-LO-SK}) 575. Further, method 800 may be performed when a target application 112 is started or open on the user computing device 108 while the end user is not logged into the service 150.

At operation 802, the end user may use the target application 112 operating on the user computing device 108 and the risky web monitor 106 may interface the target application 112 (e.g., via one or more application programming interfaces (APIs), event listeners, injection of a client-side scripting language (e.g., JavaScript) into a webpage, etc.) and monitor user interactions performed in the target application 112. In some examples, the risky web monitor 106 is configured to listen for events corresponding to actions defined as risky web activity and that may indicate a potential security threat or vulnerability. Some example actions defined as risky web activities include using a weak or compromised password on a website, visiting a malware-infected website, interacting with a phishing link, etc.

In examples, when a predefined risky web activity is determined to have occurred, the risky activity monitor 106 triggers a logging component to capture the risky web activity as an event 175 at operation 804. For instance, the risky activity monitor 106 may log the event 175 (e.g., including metadata about the risky action) in an activity log 125. The metadata may include the user's user ID, an action type, timestamp, device ID of the user computing device 108, a website where the action was performed, and/or additional details about the action.

At operation 806, the risky activity monitor 106 reads the team-service logged-out secret key (K_{Team-Service-LO-SK}) 550 and the team-enclave logged-out secret key (K_{Team-Enclave-LO-SK}) 575 from local storage.

At operation 808, a secure tunnel 111 is established between the user computing device 108 and the secure enclave 110. For instance, a handshake operation as described above may be performed, where the service 150 routes calls between the risky activity monitor 106 operating on the user computing device 108 and the secure enclave 110 to build the secure tunnel 111. In examples, the service 150 handles an exchange of an attestation provided by the secure enclave 110 that may be verified by the risky activity monitor 106. Upon verification, session keys (K_{SESSION}) 525 may be generated by the risky activity monitor 106 using a secret client key (K_{CLIENT-SK}) and a public server key (K_{SERVER-PK}) provided by the secure enclave 110 with the attestation. Following messages between the risky activity monitor 106 and the secure enclave 110 may be ciphered using the session keys (K_{SESSION}) 525.

At operation 810, the logged-out end user may be authenticated by the secure enclave 110 using the team-enclave logged-out key pair (K_{Team-Enclave-LO-SK}) 575. Methods of authenticating the team-enclave logged-out key (K_{Team-Enclave-LO}) may be similar to the methods described above of authenticating the user using the device-enclave keys (K_{Device-Enclave}) 315 and 415. For instance, the risky activity monitor 106 may use the team-enclave logged-out secret key (K_{Team-Enclave-LO-SK}) 575 to sign a challenge sent by the secure enclave 110 and the team-enclave logged-out public key (K_{Team-Enclave-LO-PK}) 575 may be used by the secure enclave 110 to verify the signature. For instance, the service 150 may handle exchanges of the challenge between the risky activity monitor 106 and the secure enclave 110.

At operation 812, the team-service logged-out key pair (K_{Team-Service-LO}) 550 may be used to authenticate calls. For instance, the risky activity monitor 106 may use the team-service logged-out secret key (K_{Team-Service-LO-SK}) 550 to sign a challenge sent by the service 150 and the team-service logged-out public key (K_{Team-Service-LO-PK}) 550 may be used by the service 150 to verify the signature. The logged-out end user may then be authenticated with the service 150 and secure enclave 110. In examples, authentication by the secure enclave 110 and the service 150 provides double authentication and increased security.

At operation 814, the activity log 125 may be received from the risky activity monitor 106 and passed to the secure enclave 110 via the secure tunnel 111 for secure and private storage.

With reference now to FIG. 8B, an example method 850 of securely and privately monitoring risky web activity on a user computing device 108 when the end user is a logged-in user is depicted. In examples, the example method 850 may be performed after method 300 or method 400 has been performed to create a device-enclave key pair (K_{Device-Enclave}) 315 or 415. Additionally, method 850 may be performed when a target application 112 is started or open on the user computing device 108 while the end user is logged into the service 150. In examples, method 850 may be performed after method 500 and method 600 or method 700 have been performed to provide the user computing device 108 with the team-service logged-out secret key (K_{Team-Service-LO-SK}) 550 and the team-enclave logged-out secret key (K_{Team-Enclave-LO-SK}) 575, although the team keys may not be used in the operations included in method 850.

At operation 852, the end user may use the target application 112 operating on the user computing device 108 and the risky web monitor 106 may interface the target application 112 (e.g., via one or more application programming interfaces (APIs), event listeners, injection of a client-side scripting language (e.g., JavaScript) into a webpage, etc.) and monitor user interactions performed in the target application 112. In some examples, the risky web monitor 106 is configured to listen for events corresponding to actions defined as risky web activity and that may indicate a potential security threat or vulnerability. Some example actions defined as risky web activities include using a weak or compromised password on a website, visiting a malware-infected website, interacting with a phishing link, etc.

In examples, when a predefined risky web activity is determined to have occurred, the risky activity monitor 106 triggers a logging component to capture the risky web activity as an event 175 at operation 854. For instance, the risky activity monitor 106 may log the event 175 (e.g., including metadata about the risky action) in an activity log 125. The metadata may include the user's user ID, an action type, timestamp, device ID of the user computing device 108, a website where the action was performed, and/or additional details about the action.

At operation 856, the risky activity monitor 106 reads the device-enclave secret key (K_{Device-Enclave-SK}) 315 or 415 from the user vault 104.

At operation 858, a secure tunnel 111 is established between the user computing device 108 and the secure enclave 110. For instance, a handshake operation as described above may be performed, where the service 150 routes calls between the risky activity monitor 106 operating on the user computing device 108 and the secure enclave 110 to build the secure tunnel 111. In examples, the service 150 handles an exchange of an attestation provided by the secure enclave 110 that may be verified by the risky activity monitor 106. Upon verification, session keys (K_{SESSION}) 525 may be generated by the risky activity monitor 106 using a secret client key (K_{CLIENT-SK}) and a public server key (K_{SERVER-PK}) provided by the secure enclave 110 with the attestation. Following messages between the risky activity monitor 106 and the secure enclave 110 may be ciphered using the session keys (K_{SESSION}) 525.

At operation 860, the logged-in end user may be authenticated by the secure enclave 110 using the device-enclave key pair (K_{Device-Enclave}) 315 or 415. For instance, a challenge may be sent by the secure enclave 110, which may be signed by the risky activity monitor 106 using the device-enclave secret key (K_{Device-Enclave-SK}) 315 or 415. The device-enclave public key (K_{Device-Enclave-PK}) 315 or 415 may then be used by the secure enclave 110 to verify the signature. The logged-in end user may then be authenticated with the with the service 150 and the secure enclave 110 as the end user.

At operation 862, the activity log 125 may be transmitted from the risky activity monitor 106 to the secure enclave 110 via the secure tunnel 111 for secure and private storage.

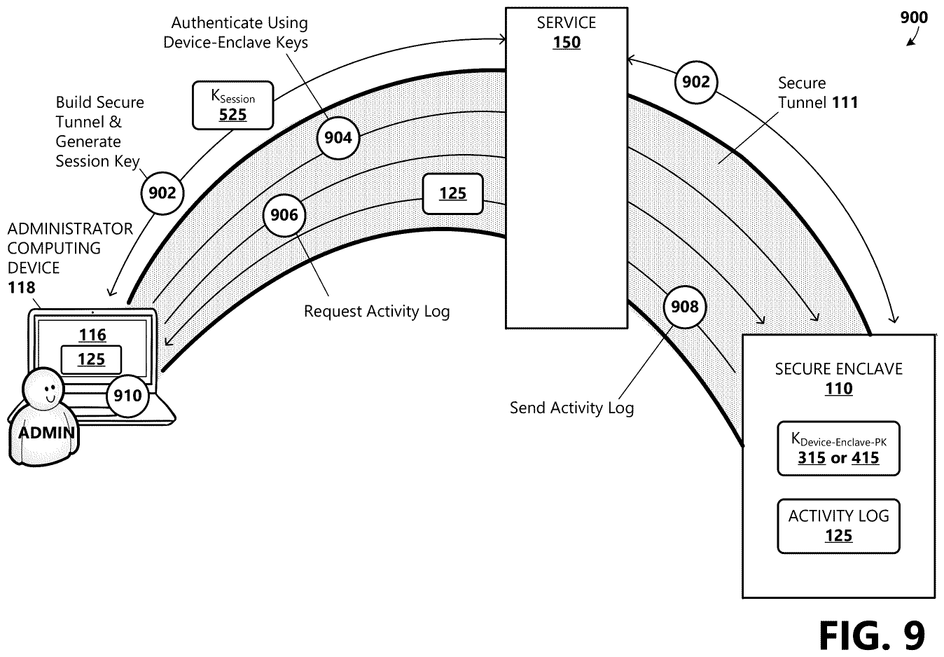

An example method 900 of securely and privately monitoring risky web activity in an enterprise computing system 103 is depicted in FIG. 9. For instance, method 900 may be performed for enabling an activity log 125 to be queried by an administrator. In examples, the example method 900 may be performed after method 800 or method 850 has been performed and an activity log 125 has been provided by the risky activity monitor 106 operating on a user computing device 108 to the secure enclave 110 for storage.

At operation 902, a secure tunnel 111 is established between the administrator computing device 118 and the secure enclave 110. For instance, a handshake operation as described above may be performed, where the service 150 routes calls between the risky activity manager 116 operating on the administrator computing device 118 and the secure enclave 110 to build the secure tunnel 111. In examples, an attestation provided by the secure enclave 110 may be verified. Upon verification, session keys (K_{SESSION}) 525 may be generated by the risky activity manager 116 using a secret client key (K_{CLIENT-SK}) and a public server key (K_{SERVER-PK}) provided by the secure enclave 110 with the attestation.

At operation 904, the administrator may be authenticated by the secure enclave 110 using the device-enclave keys (K_{Device-Enclave}) 315 or 415. For instance, the device-enclave secret key (K_{Device-Enclave-SK}) 315 or 415 may be used by the risky activity manager 116 to sign a challenge sent by the secure enclave 110 and device-enclave public key (K_{Device-Enclave-PK}) 315 or 415 may be used by the secure enclave 110 to verify the signature. The administrator and their role may then be authenticated with the service 150 and secure enclave 110.

At operation 906, a request from the risky activity manager 116 for one or more activity logs 125 or for data included in one or more activity logs 125 is received and routed to the secure enclave 110. The one or more activity logs 125 may include risky web activity captured when the end user was logged into the service 150 and/or when the end user was not logged into the service 150. In response to the request, the secure enclave 110 may send the requested activity log(s) 125 or activity log data to the risky activity manager 116 via the secure tunnel 111 at operation 908. The administrator may be provided with visibility into potential security threats or vulnerabilities in the enterprise computing system 103. For instance, by examining a logged event 175 of risky web activity, a follow-up action may be determined and performed.

In some examples, an automated action at operation 910 may be performed by the risky activity manager 116, such as flagging the event 175, querying the secure enclave 110 for additional details about the event 175, providing feedback (e.g., an alert or notification) to the end user and/or the administrator, performing a scan of the user computing device 108, quarantining the user computing device 108 from the enterprise computing system 103, and/or other automated actions). In some examples, a recommendation to reduce a potential security threat or vulnerability is provided to the end user or administrator, such as a recommendation to change a weak or compromised password and/or use a password manager to securely store and generate a strong password. In further examples, a tool may be provided by the risky activity manager 116 that may provide coaching to end users whose interactions with the target application 112 are identified as risky web activity.

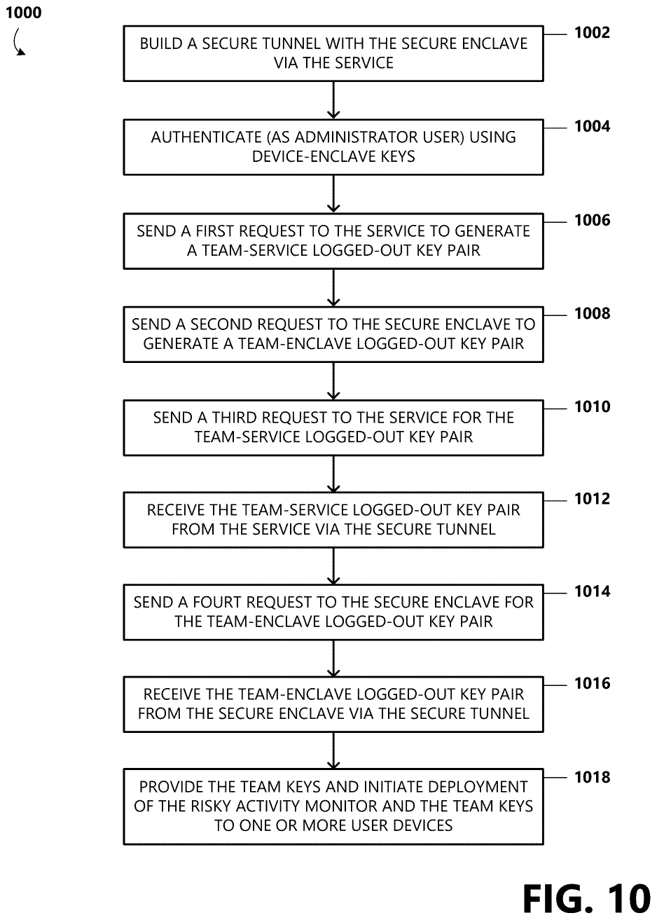

With reference now to FIG. 10, an example method 1000 of providing secure and private monitoring of risky web activity in an enterprise computing system 103 is depicted. For example, the method 1000 may be performed by a risky activity manager 116 operating on an administrator computing device 118. At operation 1002, a secure tunnel 111 is established between the risky activity manager 116 and the secure enclave 110. For instance, a handshake operation as described above may be performed, where the administrator computing device 118 uses the service 150 as a proxy to route network calls to the secure enclave 110 to build the secure tunnel 111. In examples, an attestation provided by the secure enclave 110 may be verified by the risky activity manager 116. Upon verification, the risky activity manager 116 may generate session keys (K_{SESSION}) 525 using a secret client key (K_{CLIENT-SK}) and a public server key (K_{SERVER-PK}) provided by the secure enclave 110 with the attestation.

At operation 1004, the administrator may be authenticated using device-enclave keys (K_{Device-Enclave}) 315 or 415. For instance, the risky activity manager 116 may retrieve the device-enclave secret key (K_{Device-Enclave-SK}) 315 or 415 from local storage and sign a challenge sent by the secure enclave 110. Upon verification of the signature by the secure enclave 110 using the device-enclave public key (K_{Device-Enclave-PK}) 315 or 415, the administrator and their role may be authenticated with the service 150 and secure enclave 110.

At operation 1006, a first request is sent to the service 150 to generate a team-service logged-out key pair (K_{Team-Service-LO}) 550. In response, the service 150 may create the team-service logged-out key pair (K_{Team-Service-LO}) 550. The service 150 may further store the team-service logged-out key pair (K_{Team-Service-LO}) 550.

At operation 1008, a second request is sent to the secure enclave 110 to generate a team-enclave logged-out key pair (K_{Team-Enclave-LO}) 575. In response, the secure enclave 110 may create the team-enclave logged-out key pair (K_{Team-Enclave-LO}) 575. The secure enclave 110 may further store the team-enclave logged-out key pair (K_{Team-Enclave-LO}) 575.

The method 1000 may then proceed to operation 1010. In some examples, operations 1002-1008 are performed in a first session and operations 1010-1018 may be performed in the same session or a second session (e.g., at another time). At operation 1010, a third request is sent to the service 150 for the team-service logged-out key pair (K_{Team-Service-LO}) 550. In examples, the team-service logged-out key pair (K_{Team-Service-LO}) 550 may be received by the risky activity manager 116 in response to the third request at operation 1012.

At operation 1014, a fourth request is sent to the secure enclave 110 for the team-enclave logged-out key pair (K_{Team-Enclave-LO}) 575. In response, the team-enclave logged-out key pair (K_{Team-Enclave-LO}) 575 may be received by the risky activity manager 116 in response to the fourth request at operation 1016.

At operation 1018, the team-service logged-out key pair (K_{Team-Service-LO}) 550 and the team-enclave logged-out key pair (K_{Team-Enclave-LO}) 575 are provided for deployment to one or more user computing devices 108. For instance, the team-service logged-out key pair (K_{Team-Service-LO}) 550 and the team-enclave logged-out key pair (K_{Team-Enclave-LO}) 575 may be provided to a device management system 126 that deploys the risky activity monitor 106 and the secret keys of the team-service logged-out key pair (K_{Team-Service-LO-SK}) 550 and team-enclave logged-out key pair (K_{Team-Enclave-LO-SK}) 575 to the one or more user computing devices 108. The risky activity monitor 106 on the one or more user computing devices 108 may be configured to generate activity logs 125 of risky web activity. The risky activity monitor 106 may be further configured to send the activity logs 125 to the secure enclave 110 for storage by authenticating with the secure enclave 110 as a logged-out user using the team-service logged-out key pair (K_{Team-Service-LO}) 550 and team-enclave logged-out key pair (K_{Team-Enclave-LO}) 575.

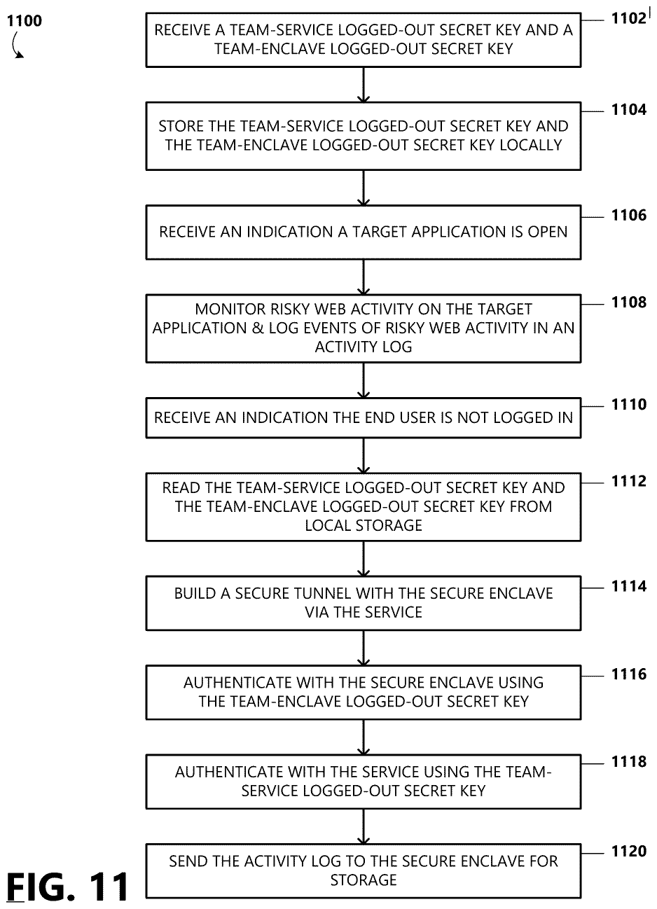

With reference now to FIG. 11, an example method 1100 of providing secure and private monitoring of risky web activity in an enterprise computing system 103 is depicted. For example, the method 1100 may be performed by a risky activity monitor 106 operating on an end user computing device 108 when the end user is not logged into the service 150 (e.g., is a logged-out user).

At operation 1102, the secret keys of the team-service logged-out key pair (K_{Team-Service-LO-SK}) 550 and team-enclave logged-out key pair (K_{Team-Enclave-LO-SK}) 575 are received by the end user computing device 108. For instance, the team-service logged-out key secret (K_{Team-Service-LO-SK}) 550 and team-enclave logged-out secret key (K_{Team-Enclave-LO-SK}) 575 may be deployed to and received by the risky activity monitor 106 at a same time or after the risky activity monitor 106 is installed on the end user computing device 108.

At operation 1104, the team-service logged-out key secret (K_{Team-Service-LO-SK}) 550 and team-enclave logged-out secret key (K_{Team-Enclave-LO-SK}) 575 may be stored locally on the end user computing device 108.

At operation 1106, an indication may be received that a target application 112 is started or open on the user computing device 108. For instance, the risky web monitor 106 may start when the target application 112 is started. At operation 1108, interactions performed in the target application 112 may be monitored. In examples, monitoring user interactions performed in the target application 112 includes listening for events 175 corresponding to actions defined as risky web activity. In examples, when a user interaction is determined as a risky web activity, a logging component may be triggered by the risky activity monitor 106 to capture the risky web activity as an event 175. For instance, the risky activity monitor 106 may log the event 175 in an activity log 125. The risky activity monitor 106 may further log metadata (e.g., the user's user ID, an action type, timestamp, device ID of the user computing device 108, a website where the action was performed, and/or additional details) about the risky action.

At operation 1110, an indication may be received that the end user is not currently logged into the service 150. For instance, the risky activity monitor 106 makes a determination the end user is a logged-out user. In examples where an indication is received that the end user is currently logged into the service 150, the device-enclave key pair 315 or 415 may be used to authenticate the end user with the secure enclave 110 (e.g., as described above in the description of FIG. 8B.

At operation 1112, the team-service logged-out secret key (K_{Team-Service-LO-SK}) 550 and the team-enclave logged-out secret key (K_{Team-Enclave-LO-SK}) 575 may be read from local storage.

At operation 1114, a secure tunnel 111 is established between the user computing device 108 and the secure enclave 110. For instance, a handshake operation as described above may be performed, where the user computing device 108 uses the service 150 as a proxy to route network calls to the secure enclave 110 to build the secure tunnel 111. In examples, an attestation provided by the secure enclave 110 may be verified by the risky activity monitor 106. Upon verification, the risky activity monitor 106 may generate session keys (K_{SESSION}) 525 using a secret client key (K_{CLIENT-SK}) and a public server key (K_{SERVER-PK}) provided by the secure enclave 110 with the attestation.

At operation 1116, the risky activity monitor 106 may authenticate with the secure enclave 110 as a logged-out end user using the team-enclave logged-out key pair (K_{Team-Enclave-LO-SK}) 575. For instance, the risky activity monitor 106 may use the team-enclave logged-out secret key (K_{Team-Enclave-LO-SK}) 575 to sign a challenge sent by the secure enclave 110 and the team-enclave logged-out public key (K_{Team-Enclave-LO-PK}) 575 may be used by the secure enclave 110 to verify the signature.

At operation 1116, the risky activity monitor 106 may authenticate with the service 150 as a logged-out end user using the team-service logged-out key pair (K_{Team-Service-LO}) 550. For instance, the risky activity monitor 106 may use the team-service logged-out secret key (K_{Team-Service-LO-SK}) 550 to sign a challenge sent by the service 150 and the team-service logged-out public key (K_{Team-Service-LO-PK}) 550 may be used by the service 150 to verify the signature. The logged-out end user may then be authenticated with the service 150 and secure enclave 110.

At operation 1118, the activity log 125 may be sent to the secure enclave 110 for secure and private storage. In examples, when the activity log 125 is received by the secure enclave 110, the activity log 125 may be queried by an administrator using the risky activity manager 116.

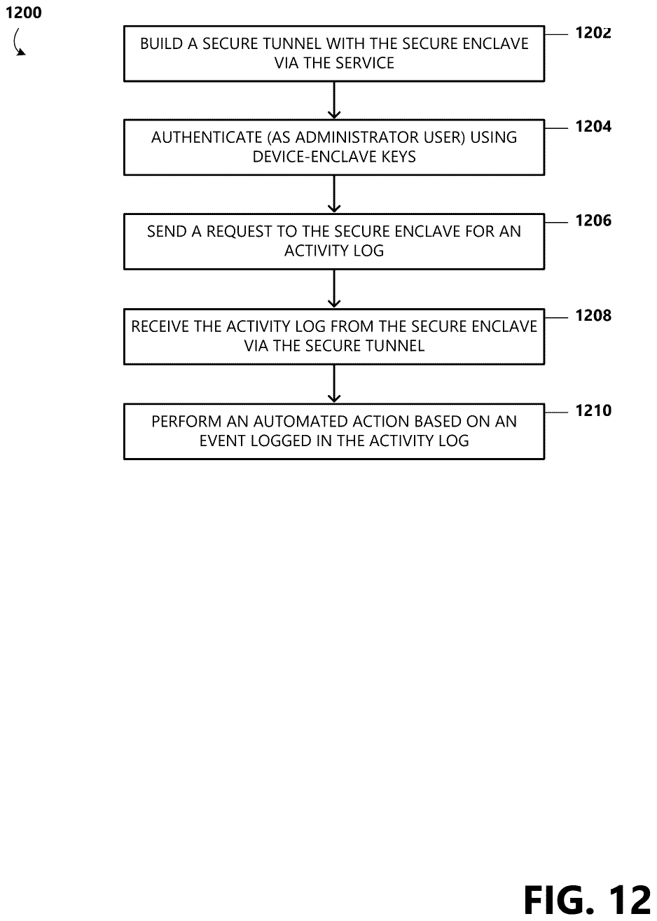

With reference now to FIG. 12, an example method 1200 of providing secure and private monitoring of risky web activity in an enterprise computing system 103 is depicted. For example, the method 1200 may be performed by a risky activity manager 116 operating on an administrator computing device 118. At operation 1202, a secure tunnel 111 is established between the administrator computing device 118 and the secure enclave 110. For instance, a handshake operation as described above may be performed, where the administrator computing device 118 uses the service 150 as a proxy to route network calls to the secure enclave 110 to build the secure tunnel 111. In examples, an attestation provided by the secure enclave 110 may be verified by the risky activity manager 116. Upon verification, the risky activity manager 116 may generate session keys (K_{SESSION}) 525 using a secret client key (K_{CLIENT-SK}) and a public server key (K_{SERVER-PK}) provided by the secure enclave 110 with the attestation.

At operation 1204, the administrator may be authenticated using the device-enclave keys (K_{Device-Enclave}) 315 or 415. For instance, the risky activity manager 116 may retrieve the device-enclave secret key (K_{Device-Enclave-SK}) 315 or 415 from local storage and sign a challenge sent by the secure enclave 110. Upon verification of the signature by the secure enclave 110 using the device-enclave public key (K_{Device-Enclave-PK}) 315 or 415, the administrator and their role may be authenticated with the service 150 and secure enclave 110.

At operation 1206, a request is sent to the secure enclave 110 for an activity log 125. For instance, a query may be made by the risky activity manager 116 for one or more activity logs 125 or for metadata included in one or more activity logs 125. In some examples, user input is received from the administrator via the user interface of the risky activity manager 116. The risky activity manager 116 may base the query on the user input. For instance, the administrator may provide user input to access activity logs 125 associated with a particular end user, access activity logs 125 received by the secure enclave 110 within a time interval, search for a specific event 175 recorded in an activity log 125, etc. In response to the request, the secure enclave 110 may send the requested activity log(s) 125 or activity log data to the risky activity manager 116 via the secure tunnel 111.

At operation 1208, the requested activity log(s) 125 or activity log data may be received by the risky activity manager 116. The administrator may be provided with visibility into potential security threats or vulnerabilities in the enterprise computing system 103. In some examples, the activity log(s) 125 or activity log data are displayed on a screen of the administrator computing device 118.

In some examples, an automated action is determined and performed at operation 1210. For instance, the risky activity manager 116 may be configured to perform an automated action based on an event 175 included in the activity log(s) 125. As an example, the risky activity manager 116 may flag the event 175, query the secure enclave 110 for additional details about the event 175, provide feedback (e.g., an alert or notification) to the end user and/or the administrator, perform a scan of the user computing device 108, quarantine the user computing device 108 from the enterprise computing system 103, provide a recommendation to the end user or the administrator, and/or perform another automated action). In some examples, the risky activity manager 116 may provide a tool that can be used to provide coaching to end users based on a logged event 175 identified as a risky web activity.

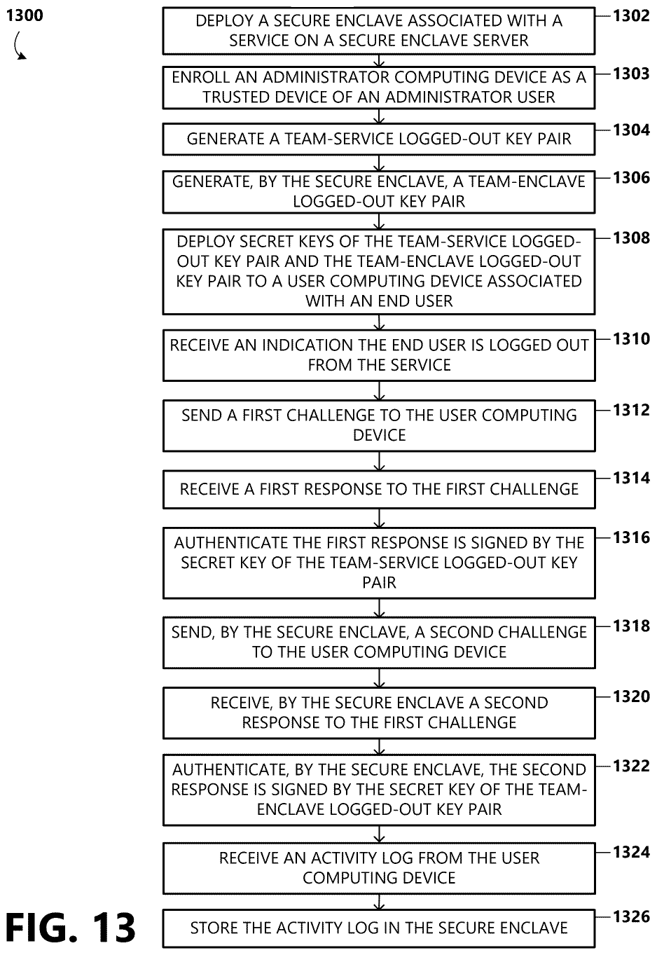

With reference now to FIG. 13, an example method 1300 of providing secure and private monitoring of risky web activity in an enterprise computing system 103 is depicted. For example, the method 1300 may be performed by the service 150. At operation 1302, a secure enclave 110 is deployed on a secure enclave server 120 provided by the secure enclave provider 160. In examples, the secure enclave 110 may be deployed using operations in the example method 200 described above with reference to FIG. 2. When the secure enclave 110 is deployed, the secure enclave 110 may be provided with an enclave local key (K_{ELK}) 235 generated by an enclave master key (K_{EMK}) 225 and a service key (K_{SERVICE}) 255 provided by the service provider 115 of the service 150.

At operation 1303, an administrator computing device 118 is enrolled as a trusted user device of an administrator user. For example, the administrator computing device 118 may be enrolled using operations in the example methods 300 and/or 400 described above with reference to FIG. 3 and FIG. 4. When the administrator computing device 118 is enrolled as a trusted user device, a device-enclave key pair (K_{Device-Enclave}) 315 or 415 may be created for the administrator and the administrator computing device 118. The secret key of the device-enclave key pair (K_{Device-Enclave-SK}) 315 or 415 may be stored in local storage on the administrator computing device 118. The public key of the device-enclave key pair (K_{Device-Enclave-PK}) 315 or 415 may be provided to the secure enclave 110 and stored for authenticating messages from the administrator computing device 118.

At operation 1304, a (public and secret) team-service logged-out key pair (K_{Team-Service-LO}) 550 may be generated. In some examples, the service 150 creates the team-service logged-out key pair (K_{Team-Service-LO}) 550 in response to receiving an authenticated request from the administrator computing device 118 for creation of the team-service logged-out key pair (K_{Team-Service-LO}) 550. In examples, the public key and the secret key of the team-service logged-out key pair (K_{Team-Service-LO}) 550 may be stored by the service 150 (e.g., on the parent server 140 or another server in the service provider infrastructure 105).

At operation 1306, a (public and secret) team-enclave logged-out key pair (K_{Team-Enclave-LO}) 575 may be generated by the secure enclave 110. In some examples, the secure enclave 110 creates the team-enclave logged-out key pair (K_{Team-Enclave-LO}) 575 in response to receiving an authenticated request from the administrator computing device 118 for the creation of the team-enclave logged-out key pair (K_{Team-Enclave-LO}) 575. In examples, the public key and the secret key of the team-enclave logged-out key pair (K_{Team-Enclave-LO}) 575 may be stored within the secure enclave 110.

At operation 1308, the team-service logged-out secret key (K_{Team-Service-LO-SK}) 550 and the team-enclave logged-out secret key (K_{Team-Enclave-LO-SK}) 575 may be deployed to the user computing device 108 associated with an end user. In some examples, the team-service logged-out secret key (K_{Team-Service-LO-SK}) 550 and the team-enclave logged-out secret key (K_{Team-Enclave-LO-SK}) 575 may be provided to one or a combination of the administrator computing device 118 or the device management system 126, which may then deploy the team logged-out secret keys (K_{Team-Service-LO-SK}) 550 and (K_{Team-Enclave-LO-SK}) 575 to the user computing device 108. In further examples, risky activity monitor 106 is installed on the user computing device 108 and the team logged-out secret keys (K_{Team-Service-LO-SK}) 550 and (K_{Team-Enclave-LO-SK}) 575 are read by the risky activity monitor 106 and stored locally on the user computing device 108.

At operation 1310, an indication may be received that the end user is not currently logged into the service 150. For instance, a request from the risky activity monitor 106 to authenticate as a logged-out end user may be received by the service 150. In examples, a secure tunnel 111 is established between the user computing device 108 and the secure enclave 110. For instance, a handshake operation as described above may be performed, and the service 150 may route network calls between the user computing device 108 and the secure enclave 110. In examples, an attestation provided by the secure enclave 110 may be verified by the risky activity monitor 106. Upon verification, the risky activity monitor 106 may generate session keys (K_{SESSION}) 525 using a secret client key (K_{CLIENT-SK}) and a public server key (K_{SERVER-PK}) provided by the secure enclave 110 with the attestation to cypher following messages.

At operation 1312, a first challenge may be generated and sent to the user computing device 108. A first response to the first challenge may be received at operation 1314. For instance, the first response may include a first signature by the risky activity monitor 106.

At operation 1316, the first signature may be authenticated. For instance, the service 150 may authenticate (e.g., using the team-service logged-out public key (K_{Team-Service-LO-PK}) 550) that the first response is signed by the team-service logged-out secret key (K_{Team-Service-LO-SK}) 550.

At operation 1318, a second challenge may be generated, by the secure enclave 110, and sent to the user computing device 108. A second response to the second challenge may be received at operation 1320. For instance, the second response may include a second signature by the risky activity monitor 106.

At operation 1322, the second signature may be authenticated. For instance, the secure enclave 110 may authenticate (e.g., using the team-enclave logged-out public key (K_{Team-Enclave-LO-PK}) 575) that the second response is signed by the team-enclave logged-out secret key (K_{Team-Enclave-LO-SK}) 575. In examples, the logged-out end user associated with the user computing device 108 may then be authenticated with the service 150 and the secure enclave 110. In examples, authentication by the secure enclave 110 and the service 150 provides double authentication and increased security.

At operation 1324, the activity log 125 is transmitted from the risky activity monitor 106 to the secure enclave 110 via the secure tunnel 111. The activity log 125 may be stored by the secure enclave 110 at operation 1326.

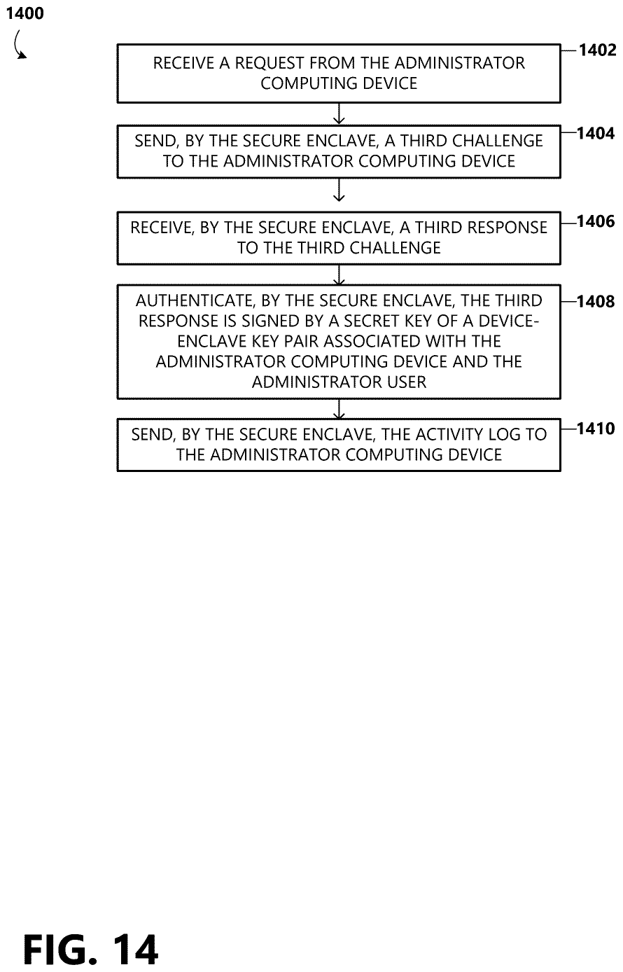

In some examples, the method 1300 continues to method 1400 depicted in FIG. 14. With reference now to FIG. 14, an example method 1400 of providing secure and private monitoring of risky web activity in an enterprise computing system 103 is depicted. At operation 1402, a request may be received from the risky activity manager 116 operating on the administrator computing device 118. In some examples, the request may be provided in association with a request for the activity log 125 received and stored in method 1300.

At operation 1404, a third challenge may be generated by the secure enclave 110 and sent to the user computing device 108. A third response to the third challenge may be received by the secure enclave 110 at operation 1406. For instance, the third response may include a third signature by the risky activity manager 116.

At operation 1408, the third signature may be authenticated. For instance, the secure enclave 110 may authenticate (e.g., using the device-enclave public key (K_{Device-Enclave-PK}) 575) that the third response is signed by the device-enclave secret key (K_{Device-Enclave-SK}) 575. In examples, the administrator and their role may then be authenticated with the secure enclave 110.

At operation 1410, the activity log 125 is transmitted from the secure enclave 110 to the risky activity manager 116 via the secure tunnel 111. In some examples, a query for particular activity log information may be made. In examples, the activity log 125 may be displayed to the administrator and/or an automated action may be performed.

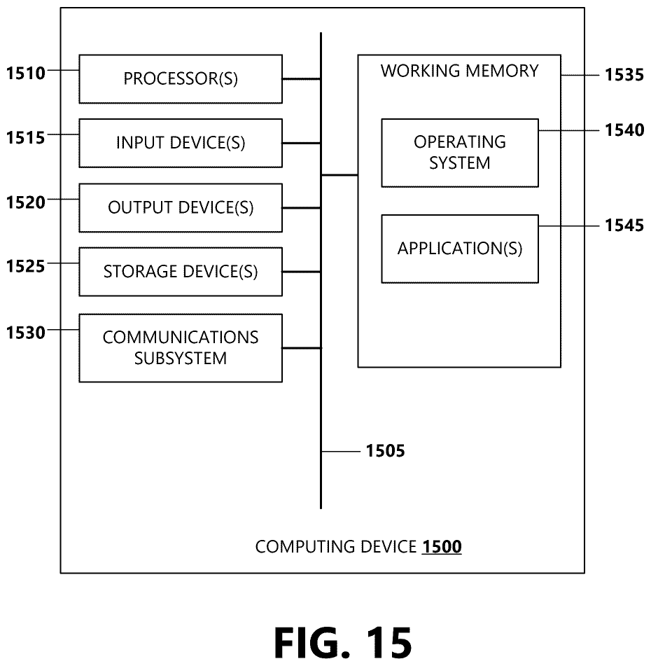

FIG. 15 is a block diagram illustrating an exemplary computer or system hardware architecture, in accordance with various embodiments. FIG. 15 provides a schematic illustration of one embodiment of a computer system 1500 of the system hardware that can perform the methods provided by various other embodiments, as described herein, and/or can perform the functions of computer or hardware system (i.e., user devices, service provider devices, etc., as described above. It should be noted that FIG. 15 is meant only to provide a generalized illustration of various components, of which one or more (or none) of each may be utilized as appropriate. FIG. 15, therefore, broadly illustrates how individual system elements may be implemented in a relatively separated or relatively more integrated manner.

The computer (or hardware) system 1500, which may represent an embodiment of the computer or hardware system(s) described above with respect to earlier figures, is shown comprising hardware elements that can be electrically coupled via a bus 1505 (or may otherwise be in communication, as appropriate). The hardware elements may include one or more processors 1510, including, without limitation, one or more general-purpose processors and/or one or more special-purpose processors (such as microprocessors, digital signal processing chips, graphics acceleration processors, and/or the like); one or more input devices 1515, which can include, without limitation, a mouse, a keyboard, and/or the like; and one or more output devices 1520, which can include, without limitation, a display device, a printer, and/or the like.

The computer or hardware system 1500 may further include (and/or be in communication with) one or more storage devices 1525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 1500 might also include a communications subsystem 1530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 1530 may permit data to be exchanged with a network, with other computer or hardware systems, and/or with any other devices described herein. In many embodiments, the computer or hardware system 1500 will further comprise a working memory 1535, which can include a RAM or ROM device, as described above.

The computer or hardware system 1500 also may comprise software elements, shown as being currently located within the working memory 1535, including an operating system 1540, device drivers, executable libraries, and/or other code, such as one or more applications 1545, which may comprise computer programs (e.g., the service 150, the secure enclave 110, the risky activity monitor 106, the risky activity manager 116, the target application 112, and/or the device management system 126) provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) 200, 300, 400, 500, 600, 700, 800, 850, 900, 1000, 1100, and/or 1200 discussed above might be implemented as code and/or instructions executable by a computer (and/or a processor within a computer); in an aspect, then, such code and/or instructions can be used to configure and/or adapt a general-purpose computer (or other device) to perform one or more operations in accordance with the described methods.

A set of these instructions and/or code might be encoded and/or stored on a non-transitory computer readable storage medium, such as the storage device(s) 1525 described above. In some cases, the storage medium might be incorporated within a computer system, such as the system 1500. In other embodiments, the storage medium might be separate from a computer system (i.e., a removable medium, such as a compact disc, etc.), and/or provided in an installation package, such that the storage medium can be used to program, configure, and/or adapt a general-purpose computer with the instructions/code stored thereon. These instructions might take the form of executable code, which is executable by the computer or hardware system 1500 and/or might take the form of source and/or installable code, which, upon compilation and/or installation on the computer or hardware system 1500 (e.g., using any of a variety of generally available compilers, installation programs, compression/decompression utilities, etc.) then takes the form of executable code.

As discussed, the computer system 1500 may include one or more secure enclave(s) 110. That is one or more of the resources (e.g., processor(s) 1510, working memory 1535, and/or application(s) 1545, among other things) may be duplicated and/or allocated to one or more secure enclave(s) within computer system 1500. In examples, a secure enclave may also be referred to as a trusted execution environment. The secure enclave may comprise a computing environment that provides isolation for code and data from the operating system 1540 using either hardware-based isolation or isolating an entire virtual machine by placing the hypervisor within a trusted computing base. In examples, users with physical and/or root access to the computer system 1500 and operating system 1540 are prevented from accessing the contents of the secure enclave memory or tampering with the execution of code within the secure enclave. Nonexclusive, nonlimiting examples of secure enclaves are available for consumer electronics devices, computers/servers, data centers, etc., including from vendors such as Intel, AMD, and Amazon Web Services. Other examples of secure enclaves are possible and contemplated.

It will be apparent to those skilled in the art that substantial variations may be made in accordance with specific requirements. For example, customized hardware (such as programmable logic controllers, field-programmable gate arrays, application-Specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 1500) to perform methods in accordance with various embodiments of the invention. According to a set of embodiments, some or all of the procedures of such methods are performed by the computer or hardware system 1500 in response to processor 1510 executing one or more sequences of one or more instructions (which might be incorporated into the operating system 1540 and/or other code, such as an application 1545) contained in the working memory 1535. Such instructions may be read into the working memory 1535 from another computer readable medium, such as one or more of the storage device(s) 1525. Merely by way of example, execution of the sequences of instructions contained in the working memory 1535 might cause the processor(s) 1510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 1500, various computer readable media might be involved in providing instructions/code to processor(s) 1510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 1525. Volatile media includes, without limitation, dynamic memory, such as the working memory 1535. In some alternative embodiments, a computer readable medium may take the form of transmission media, which includes, without limitation, coaxial cables, copper wire, and fiber optics, including the wires that comprise the bus 1505, as well as the various components of the communication subsystem 1530 (and/or the media by which the communications subsystem 1530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 1510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 1500. These signals, which might be in the form of electromagnetic signals, acoustic signals, optical signals, and/or the like, are all examples of carrier waves on which instructions can be encoded, in accordance with various embodiments of the present application.

The communications subsystem 1530 (and/or components thereof) generally will receive the signals, and the bus 1505 then might carry the signals (and/or the data, instructions, etc., carried by the signals) to the working memory 1535, from which the processor(s) 1510 retrieves and executes the instructions. The instructions received by the working memory 1535 may optionally be stored on a storage device 1525 either before or after execution by the processor(s) 1510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

We claim:

1. A method, comprising:
generating, by a service, a team-service logged-out key pair, including a team-service logged-out public key and a team-service logged-out secret key;
generating, by a secure enclave associated with the service, a team-enclave logged-out key pair, including a team-enclave logged-out public key and a team-enclave logged-out secret key;
deploying the team-service logged-out secret key and the team-enclave logged-out secret key to a first computing device associated with a first user; and
while the first user is logged out from the service:
sending, by the service, a first challenge to the first computing device;
receiving, by the service, a first response to the first challenge;
authenticating, by the service and using the team-service logged-out public key, the first response is signed by the team-service logged-out secret key;
sending, by the secure enclave, a second challenge to the first computing device;
receiving, by the secure enclave, a second response to the second challenge;
authenticating, by the secure enclave and using the team-enclave logged-out public key, the second response is signed by the team-enclave logged-out secret key; and
receiving, from a first client application associated with the service and deployed on the first computing device, a first activity log of risky web activity detected in a target application.

2. The method of claim 1, further comprising:
receiving a request for the first activity log from a second client application associated with the service and deployed on a second computing device associated with a second user;
sending, by the secure enclave, a third challenge to the second computing device;
receiving, by the secure enclave, a third response to the third challenge;
authenticating, by the secure enclave and using a device-enclave public key of a device-enclave key pair associated with the second computing device and the second user, the third response is signed by a device-enclave secret key of the device-enclave key pair; and
providing, by the secure enclave, the first activity log of risky web activity to the second client application.

3. The method of claim 2, wherein:
authenticating the first response and the second response comprises authenticating a first role associated with the first user, where the first role is a regular end user role; and
authenticating the third response comprises authenticating a second role associated with the second user, where the second role is an administrator role.

4. The method of claim 1, wherein prior to sending the first challenge to the first computing device, establishing a secure tunnel for communications between the first computing device and the secure enclave.

5. The method of claim 1, wherein prior to generating the team-enclave logged-out key pair, deploying the secure enclave on a secure enclave server.

6. The method of claim 1, wherein deploying the team-service logged-out secret key and the team-enclave logged-out secret key to the first computing device comprises providing the team-service logged-out secret key and the team-enclave logged-out key pair to a second client application associated with the service and deployed on a second computing device associated with a second user.

7. The method of claim 1, further comprising:
while the first user is logged into the service:
sending, by the service, a third challenge to the first computing device;
receiving, by the service, a third response to the first challenge;
authenticating, by the service and using a device-service public key of a device-service key pair associated with the first computing device and the first user, third response is signed by a device-service secret key of the key pair;
sending, by the secure enclave, a fourth challenge to the first computing device;
receiving, by the secure enclave, a fourth response to the fourth challenge;
authenticating, by the secure enclave and using a device-enclave public key of a device-enclave key pair associated with the first computing device and the first user, the fourth response is signed by a device-enclave secret key of the device-enclave key pair; and
receiving, from the first client application, a second activity log of risky web activity detected in a target application.

8. A system, comprising:
one or more processors; and
memory including instructions, which when executed by the one or more processors, cause the system to perform operations comprising:
generating, by a service, a team-service logged-out key pair, including a team-service logged-out public key and a team-service logged-out secret key;
generating, by a secure enclave associated with the service, a team-enclave logged-out key pair, including a team-enclave logged-out public key and a team-enclave logged-out secret key;
deploying the team-service logged-out secret key and the team-enclave logged-out secret key to a first computing device associated with a first user; and
while the first user is logged out from the service:
sending, by the service, a first challenge to the first computing device;
receiving, by the service, a first response to the first challenge;
authenticating, by the service and using the team-service logged-out public key, the first response is signed by the team-service logged-out secret key;
sending, by the secure enclave, a second challenge to the first computing device;
receiving, by the secure enclave, a second response to the second challenge;
authenticating, by the secure enclave and using the team-enclave logged-out public key, the second response is signed by the team-enclave logged-out secret key; and
receiving, from a first client application associated with the service and deployed on the first computing device, a first activity log of risky web activity detected in a target application.

9. The system of claim 8, wherein the operations further comprise:
receiving a request for the first activity log from a second client application associated with the service and deployed on a second computing device associated with a second user;
sending, by the secure enclave, a third challenge to the second computing device;
receiving, by the secure enclave, a third response to the third challenge;
authenticating, by the secure enclave and using a device-enclave public key of a device-enclave key pair associated with the second computing device and the second user, the third response is signed by a device-enclave secret key of the device-enclave key pair; and
providing, by the secure enclave, the first activity log of risky web activity to the second client application.

10. The system of claim 9, wherein:
authenticating the first response and the second response comprises authenticating a first role associated with the first user, where the first role is a regular end user role; and
authenticating the third response comprises authenticating a second role associated with the second user, where the second role is an administrator role.

11. The system of claim 8, wherein prior to sending the first challenge to the first computing device, establishing a secure tunnel for communications between the first computing device and the secure enclave.

12. The system of claim 8, wherein prior to generating the team-enclave logged-out key pair, deploying the secure enclave on a secure enclave server.

13. The system of claim 8, wherein deploying the team-service logged-out secret key and the team-enclave logged-out secret key to the first computing device comprises providing the team-service logged-out secret key and the team-enclave logged-out key pair to a second client application associated with the service and deployed on a second computing device associated with a second user.

14. The system of claim 8, wherein the first activity log includes a logged event of the risky web activity detected in the target application.

15. The system of claim 8, wherein:
the target application is a web browser; and
the first client application is a web browser extension.

16. A method, comprising:
receiving a first challenge from a service;
authenticating with the service by signing the first challenge with a device-service secret key of a device-service key pair associated with an administrator computing device and an administrator user;
providing a first request to the service for creation of a team-service logged-out key pair, including a team-service logged-out public key and a team-service logged-out secret key;
receiving a first response to the first request from the service including the team-service logged-out key pair;
receiving a second challenge from a secure enclave associated with the service;
authenticating with the secure enclave by signing the second challenge with a device-enclave secret key of a device-enclave key pair associated with the administrator computing device and the administrator user;
providing a second request to the secure enclave for creation of a team-enclave logged-out key pair, including a team-enclave logged-out public key and a team-enclave logged-out secret key;
receiving a second response to the second request from the secure enclave including the team-enclave logged-out key pair;
deploying a risky activity monitor associated with the service on a user computing device associated with an end user;
deploying the team-service logged-out secret key and the team-enclave logged-out secret key to the user computing device; and
configuring the risky activity monitor to:
monitor a target application;
detect a risky event;
log the risky event in an activity log;
receive an indication the end user is logged out from the service;
authenticate with the service using the team-service logged-out key pair;
authenticate with the secure enclave using the team-enclave logged-out key pair; and
send the activity log to the secure enclave.

17. The method of claim 16, further comprising:
sending a request for the activity log to the secure enclave;
receiving a third challenge from the secure enclave;
authenticating with the secure enclave by signing the third challenge with the device-enclave secret key; and
receiving the activity log from the secure enclave.

18. The method of claim 17, further comprising displaying the activity log on a screen of the administrator computing device.

19. The method of claim 17, further comprising performing an automated action based on the risky event in the activity log.

20. The method of claim 16, wherein:
deploying the risky activity monitor comprises sending a first deployment request to a device management system to deploy the risky activity monitor on the user computing device; and
deploying the team-service logged-out secret key and the team-enclave logged-out secret key comprises:
sending the team-service logged-out key pair to the device management system;
sending the team-enclave logged-out key pair to the device management system; and
sending a second deployment request to the device management system to deploy the team-service logged-out key pair and the team-enclave logged-out key pair to the second computing device.
